(19) United States
(12) Patent Application Publication
(10) Pub. No.: US 2022/0012572 A1
(43) Pub. Date: Jan. 13, 2022

(54) EFFICIENT SEARCH OF ROBUST ACCURATE NEURAL NETWORKS

(71) Applicants: International Business Machines Corporation, Armonk, NY (US); Rensselaer Polytechnic Institute, Troy, NY (US)

(72) Inventors: Pin-Yu Chen, White Plains, NY (US); Payel Das, Yorktown Heights, NY (US); Igor Melnyk, White Plains, NY (US); Prasanna Sattigeri, Acton, MA (US); Rongjie Lai, Clifton Park, NY (US); Norman Tatro, Troy, NY (US)

(21) Appl. No.: 16/926,407

(22) Filed: Jul. 10, 2020

(51) Int. Cl. G06N 3/063; G06N 3/04; G06N 3/08

(52) U.S. Cl. CPC G06N 3/063; G06N 3/08; G06N 3/0454

(57) ABSTRACT

With at least one hardware processor, obtain data specifying: two trained neural network models; and alignment data. With the at least one hardware processor, carry out neuron alignment on the two trained neural network models using the alignment data to obtain two aligned models. With the at least one hardware processor, train a minimal loss curve between the two aligned models. With the at least one hardware processor, select a new model along the minimal loss curve that maximizes accuracy on adversarially perturbed data.

### STATEMENT REGARDING PRIOR DISCLOSURES BY THE INVENTOR OR A JOINT INVENTOR

The following disclosure(s) are submitted under 35 U.S.C. 102(b)(1)(A):

N. Joseph Tatro, Pin-Yu Chen, Payel Das, Igor Melnyk, Prasanna Sattigeri, Rongjie Lai, Optimizing Loss Landscape Connectivity via Neuron Alignment, 25 Sep. 2019 version 1, ICLR 2020 Conference Blind Submission.

N. Joseph Tatro, Pin-Yu Chen, Payel Das, Igor Melnyk, Prasanna Sattigeri, Rongjie Lai, Optimizing Loss Landscape Connectivity via Neuron Alignment, 24 Dec. 2019 version 2, ICLR 2020 Conference Blind Submission.

### BACKGROUND

The present invention relates to the electrical, electronic and computer arts, and more specifically, to artificial intelligence (AI) and the like.

The loss landscapes of deep neural networks are not well understood due to their high nonconvexity. Empirically, the local minima of these loss functions can be connected by a learned curve in model space, along which the loss remains nearly constant; a feature known as mode connectivity. However, current path finding algorithms do not consider the influence of symmetry in the loss surface created by model weight permutations.

### SUMMARY

Principles of the invention provide techniques for efficient search of robust accurate neural networks. In one aspect, an exemplary method includes obtaining, with at least one hardware processor, data specifying: two trained neural network models; and alignment data; with the at least one hardware processor, carrying out neuron alignment on the two trained neural network models using the alignment data to obtain two aligned models; with the at least one hardware processor, training a minimal loss curve between the two aligned models; and with the at least one hardware processor, selecting a new model along the minimal loss curve that maximizes accuracy on adversarially perturbed data.

In another aspect, an exemplary apparatus includes a memory; a non-transitory computer readable medium including computer executable instructions; and at least one processor, coupled to the memory and the non-transitory computer readable medium, and operative to execute the instructions to be operative to obtain data specifying: two trained neural network models; and alignment data; carry out neuron alignment on the two trained neural network models using the alignment data to obtain two aligned models; train a minimal loss curve between the two aligned models; and select a new model along the minimal loss curve that maximizes accuracy on adversarially perturbed data.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects. For example, one or more embodiments provide one or more of:

enhanced speed, as compared to naïve hyperparameter-tuning, in learning the optimal robust model, thus improving the performance of a computer implementing an artificial intelligence system by reducing the number of CPU cycles compared to the prior art;

improved performance of computer-implemented artificial intelligence systems (enhanced robustness while maintaining accuracy on clean data) with manageable cost;

method and system for efficient search of robust accurate neural networks that is scalable and cost-effective, and provides comprehensive robustness improvement;

improved accuracy in selecting an adversarially robust model from an aligned curve connecting robust models;

increased robustness in the model selected from the aligned curve;

increased speed, compared to hyperparameter-tuning, in learning the optimal robust model, and with improved robustness accuracy trade-off;

ability to align two neural networks;

ability to aggregate different models on a curve to improve performance.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts a cloud computing environment according to an embodiment of the present invention;

FIG. 2 depicts abstraction model layers according to an embodiment of the present invention;

FIG. 3 shows an adversarial attack that can be overcome with aspects of the invention;

FIGS. 4A, 4B, and 4C show paths determined with aspects of the invention;

FIGS. 5A, 5B, 6A, 6B, and 7 show exemplary results;

FIG. 8 shows a combined flow chart and block diagram according to aspects of the invention;

FIGS. 9A, 9B, 10A, 10B, 11A, 11B, 12A, 12B, 13A, 13B, and 13C show exemplary results;

FIG. 14 shows an exemplary neuron alignment algorithm, according to an aspect of the invention;

FIGS. 15, 16A, 16B, 16C, 17A, 17B, 17C, 18A, 18B, and 18C show exemplary results;

FIG. 19 depicts a computer system that may be useful in implementing one or more aspects and/or elements of the invention, also representative of a cloud computing node according to an embodiment of the present invention;

FIGS. 20A, 20B, 20C, 21A, 21B, 21C, 22A, 22B, 22C, 23A, 23B, 23C, 24A, 24B, 24C, 25A, 25B, 25C, 26A, 26B, 26C, 27A, 27B, 27C, 28A, 28B, 28C, 29A, 29B, 29C, 30A, 30B, 30C, 31A, 31B, 31C, 32A, 32B, 32C, 33A, 33B, 33C, 34A, 34B, 34C, 35A, 35B, 35C, 36A, 36B, 36C, 37A, 37B, 37C, 38A, 38B, 38C, 39A, 39B, 39C, 40A, 40B, 40C, 41A, 41B, 41C, 42A, 42B, 42C, 43A, 43B, 43C, 44A, 44B, 44C, 45, 46, 47, 48A, 48B, and 48C show exemplary results;

FIG. 49 shows an exemplary curve finding algorithm, according to an aspect of the invention; and

FIGS. 50A, 50B, 50C, 51A, 51B 51C, 52A, 52B, 52C, 53A, 53B, 53C, 54A, 54B, 54C, 55A, 55B, 55C, 56A, 56B, 56C, 57A, 57B, 57C, 58A, 58B, 58C, 59A, 59B, 59C, 60A, 60B, and 60C show exemplary results.

### DETAILED DESCRIPTION

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

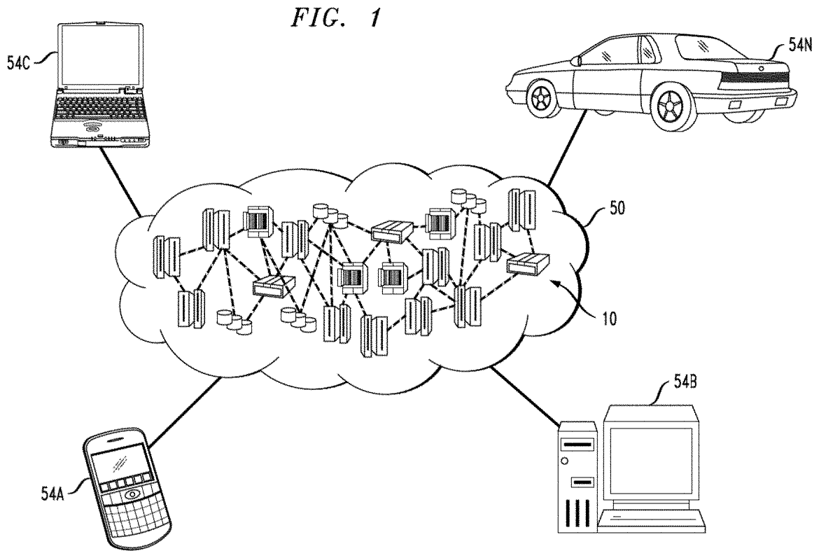

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

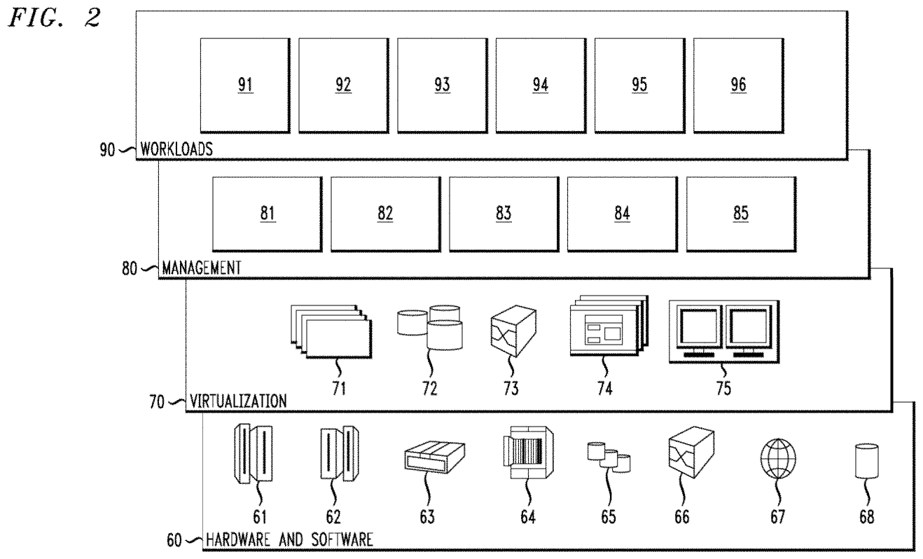

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and a cloud-based service 96 (or one or more elements thereof) to facilitate efficient search of robust accurate neural networks.

Aspects of the invention advantageously make artificial intelligence (AI) more trustworthy/robust. AI models are often accurate but not robust; i.e. they work well on “legitimate” data but can be easily manipulated by an adversary, causing the recognition to go wrong. One or more embodiments enhance robustness against malicious attack, effectively enhancing model robustness to new and adversarial environments. The training is advantageously scalable, effective, and computationally efficient, and supports two endeavors: (i) the utility (standard accuracy) on the clean data is not compromised; and (ii) the robustness (accuracy under attack) on perturbed data samples is maximized.

FIG. 3 shows how a small perturbation 303 can be used to cause mis-classification (e.g. perceived as green light at 305 instead of correctly as stop sign 301). Neural networks are trained for various tasks such as classification and regression. Models can be susceptible to adversarial attacks, such as noise being injected into an image to cause misclassification. Models can be trained such that they are adversarially robust, where the effects of adversarial attacks are minimized. Heretofore, the training of adversarially robust models has come at the cost of performance on clean data which has not experienced an adversarial attack.

There are a number of challenges in finding models that are simultaneously robust and accurate, including the tradeoff between robustness and accuracy. There exists a best-performance model but it is not currently known how to search for it efficiently. One or more embodiments leverage mode connectivity of neural networks for efficient search. A first challenge is that determining the hyperparameters for learning the optimal adversarially robust model is expensive. The state of the art for learning robust models is adversarial training. Adversarial training is more expensive than traditional training of the network. A naïve approach to training the most optimal model is hyperparameter search. This search scales linearly and quickly becomes prohibitively expensive. A second challenge is that there is a tradeoff between robustness and accuracy in the training of robust models. Adversarial training minimizes robust loss; that is, the loss associated with training data that has been compromised by adversarial attacks. Then, the accuracy on the clean training data is not directly being optimized, and adversarial training may fail to learn a model of comparable robustness with higher accuracy.

Current mode connectivity solutions seek to find a path of models between two trained networks, but do not address robust model search and/or consider weight symmetry. Current adversarial training approaches typically suffer from a large drop in standard accuracy, with an undesirable robustness-accuracy tradeoff. As for current approaches to connecting adversarially robust models, without resolving weight ambiguity, it is not feasible to find better models. Thus, the current state of art includes adversarial training but it must trade accuracy for robustness and the training itself is very expensive and current techniques are not scalable. It is necessary to carefully choose a significant number of hyperparameters to find the desired model. Mode connectivity addresses how models of similar performance are related in a geometric sense. There is actually a path connecting different models of similar performance. Searching in the space of ALL models would be very difficult; however, in accordance with one or more embodiments, if it is known that there are some path(s) connecting the good models, these paths can be found and searching can be concentrated on those paths in order to find good models.

One or more embodiments address these challenges by leveraging the mode connectivity of neural networks, providing more robust models via aligned mode connectivity (BRMAMC). Examine the geometric properties of neural network models and use these properties to carry out an efficient search for a robust and accurate model, simultaneously improving both robustness and accuracy. Knowledge of the paths connecting good models allows embodiments of the invention to be efficient. There have been previous attempts to do mode connection and adversarial training at the same time. However, without use of embodiments of the invention, these have been unsuccessful.

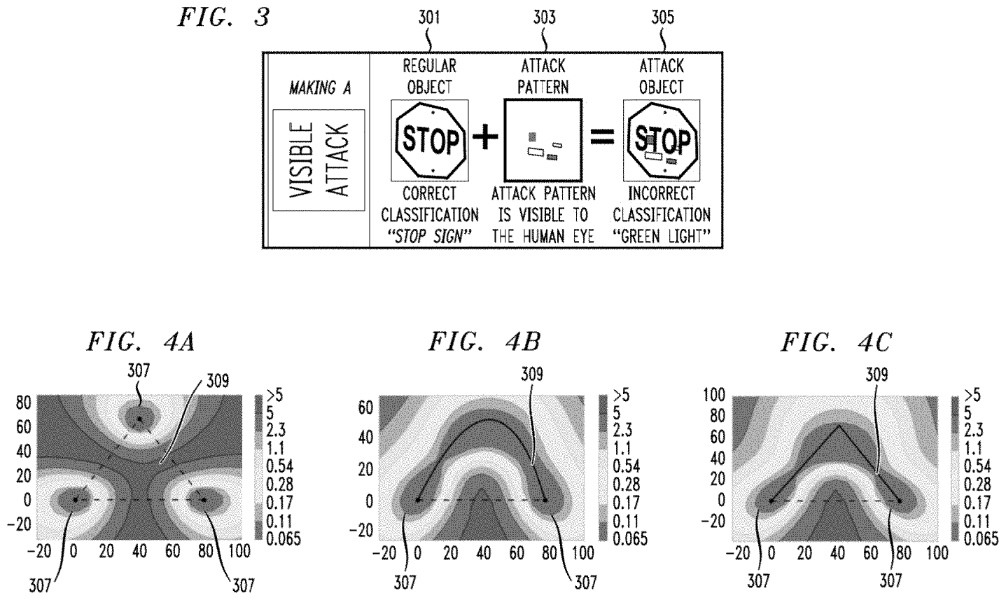

Referring to FIGS. 4A-4C, the regions 307 are the good models. The paths 309 highlighted in black connect the good models 307 (mode connectivity). Methods according to one or more embodiments find the paths 309 and then search for better models along the paths. One or more embodiments align the models before finding the path. We have found that this alignment process is quite pertinent to finding good models.

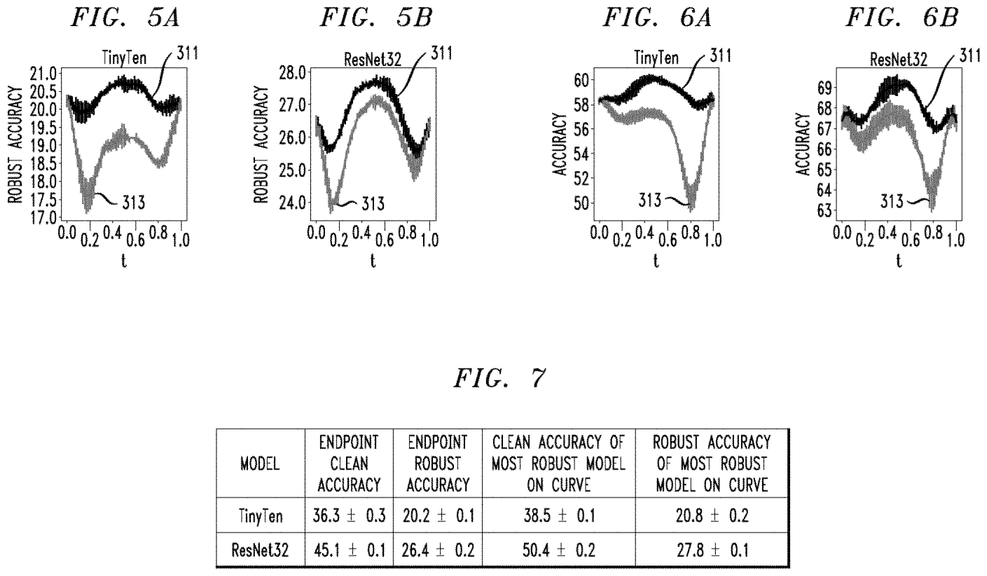

The curves in FIGS. 5A-6B show results 311 with alignment (embodiments of invention) and 313 without alignment (prior art). Advantageously, using embodiments of the invention 311 it is possible to find a better model in terms of accuracy as compared to the two starting models. Starting with two given models, follow the path to a better model using embodiments of the invention. The vertical axis units are percentage. The horizontal axis t is the location of the model on the path: 0.0=first model, 1.0=second model. FIGS. 5A and 5B show robust accuracy (accuracy on malicious/adversarial data), while FIGS. 6A and 6B show standard accuracy (i.e. accuracy on clean data). One or more embodiments thus allow identification of a model that is simultaneously more robust and more accurate by using alignment techniques of embodiments of the invention.

One or more embodiments align the independently trained networks before connecting them (by maximizing the correlation of activation maps). BRMAMC provides a curve of fully trained robust models for the cost of training three robust models. With neuron alignment, these models are seen to generalize as well as individually trained models. On non-trivial datasets, such as CIFAR100, we have found that a model can be found that is both more accurate and robust along the curve than either of the endpoints.

Still referring to FIGS. 4A-4C, starting with the two models, the objective is to find a better model. First, carry out alignment between the two existing models by looking into their activation values over the training dataset. Align the activation functions. After alignment, learn the path 309. The path indicates similar performance models. Then, search the path to see if there is a better model than the two end models.

In one or more embodiments, the training objective is curve finding up to symmetry. In one or more embodiments, BRMAMC includes neuron alignment, plus curve finding, plus model selection. One or more embodiments use a neuron alignment technique for solving permutations, wherein the model weights are permuted so that hidden states of two models are maximally correlated. In curve finding, learn a parameterized curve on the loss surface along which average loss is minimized. In model selection, evaluate models along the curve and select the most robust model. Refer to equations (5) and (6) below.

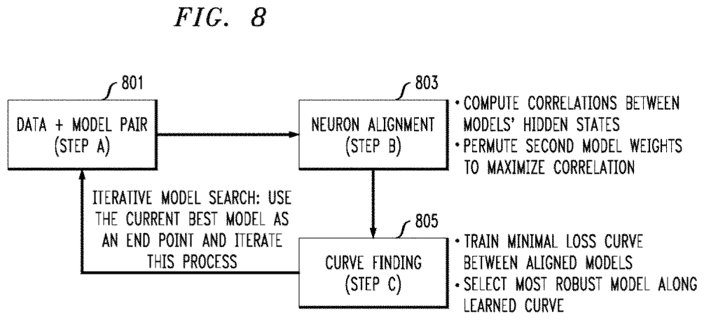

Referring to FIG. 8, given training data and two models 801, use the data to determine the activation functions of the neural network. In step 803, align the activation functions via permutation. After alignment, connect the two models by finding a path in step 805. Then, search for the best model on the path. This can be done iteratively; i.e., use the best model as an endpoint and look for an even better model.

Referring to Algorithm 1 in FIG. 14 (Input), referring to Step A 801 in FIG. 8, in one or more embodiments, there are no assumptions on the data and the model—any neural network and any user-provided data can be employed, as well as any amount of data. Indeed, in one or more embodiments, there is no limitation on the ML model (user provided), as long as the models in the model pair have the same architecture. The data required does not necessarily need to be a subset of the training data, just similar in distribution and disjoint from the test data.

Still referring to Algorithm 1 in FIG. 14 (Output and nested FOR loops), and referring to Step B 803 in FIG. 8, in one or more embodiments, given a model pair, use the available data to find the activation function and how to align the model pairs. Permute one model in a model pair to make it aligned by maximizing the correlation. In particular, compute the correlation matrix between network pairs' hidden states at each layer, permute the second model weights to maximize correlation between corresponding hidden states, and use the Hungarian algorithm to solve the linear assignment problem (any other valid algorithm can be used).

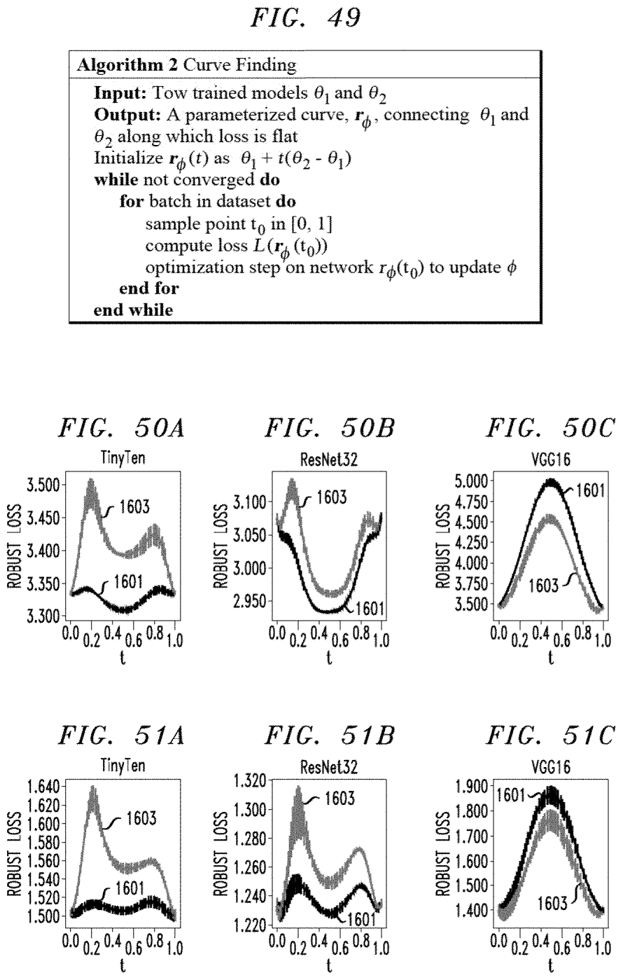

Referring to Algorithm 2 in FIG. 49, and referring to Step C 805 in FIG. 8, in one or more embodiments, once the two given models are aligned, the next step is learning the path connecting the two models. With aligned models, train a minimal loss curve between them. Select that model along the learned curve that maximizes accuracy on adversarially perturbed data. This process can be made iteratively by making the current best model as a new end point and reconnect.

Referring to the table of FIG. 7, the second and third columns show the starting points while the fourth and fifth columns show improvements using aspects of invention. Also, cost is manageable in one or more embodiments: the additional cost is equivalent to just training an additional neural network model. Systems employing aspects of the invention can handle adversarial attacks better than prior art systems with manageable training cost. Search techniques according to aspects of the invention are efficient; they are superior to doing a blind search. Thus, one or more embodiments improve the performance of computer-implemented artificial intelligence systems (enhanced robustness while maintaining accuracy on clean data) with manageable cost.

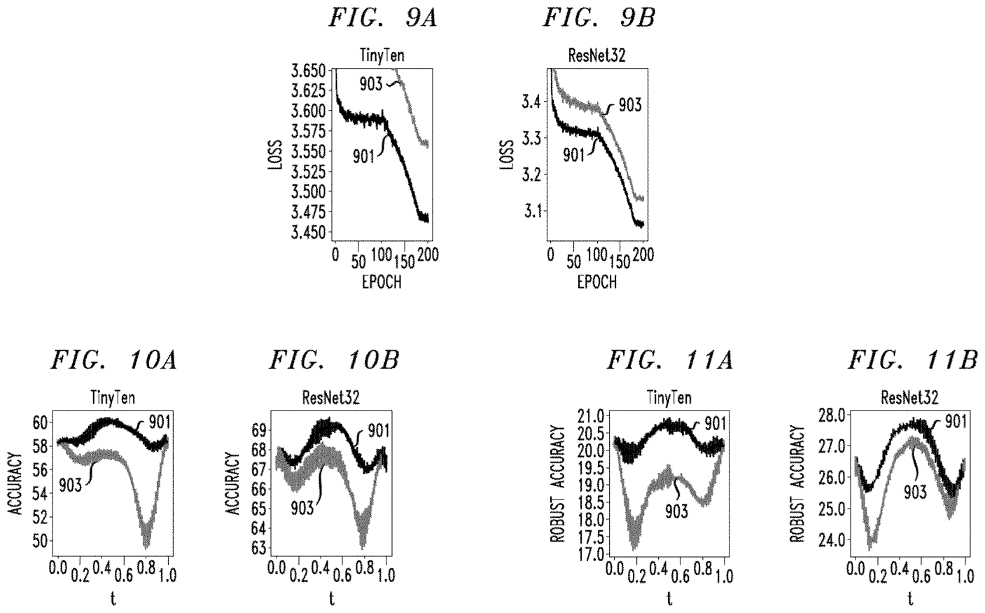

FIGS. 9A-11B show performance plots. Referring to FIGS. 9A and 9B, embodiments using alignment, labeled 901, make the training loss drop faster as compared to the prior art 903, which means that the system can better train an optimized model. FIGS. 10A and 10B show accuracy and FIGS. 11A and 11B show robust accuracy with (at 901) and without (903) alignment. Without alignment, there is no guarantee to find a model that is robust and accurate at the same time. Compare to lines 901 with alignment and note improved accuracy and robustness.

One or more embodiments thus advantageously provide a method and system for efficient search of robust accurate neural networks that is scalable and cost-effective, and provides comprehensive robustness improvement; improved accuracy in selecting an adversarially robust model from an aligned curve connecting robust models; and increased robustness in the model selected from the aligned curve. One or more embodiments are faster, compared to hyperparameter-tuning, in learning the optimal robust model, and provide improved robustness accuracy trade-off. Advantageously, one or more embodiments are faster, as compared to naïve hyperparameter-tuning, in learning the optimal robust model, thus improving the performance of the computer implementing an artificial intelligence system by reducing the number of CPU cycles compared to the prior art.

As noted, the loss landscapes of deep neural networks are not well understood due to their high nonconvexity. Empirically, the local minima of these loss functions can be connected by a learned curve in model space, along which the loss remains nearly constant; a feature known as mode connectivity. However, current path finding algorithms do not consider the influence of symmetry in the loss surface created by model weight permutations. One or more embodiments advantageously provide a framework to investigate the effect of symmetry on landscape connectivity by directly optimizing the weight permutations of the networks being connected. To learn a locally optimal permutation, one or more embodiments include both a proximal alternating minimization scheme with some convergence guarantees as well as an inexpensive heuristic referred to as neuron alignment. Empirically, optimizing the weight permutation is pertinent for efficiently learning a simple, planar, low-loss curve between networks that successfully generalizes. Surprisingly, an alignment method according to one or more embodiments can significantly alleviate the recently identified robust loss barrier on the path connecting two adversarial robust models and find more robust and accurate models on the path.

Loss surfaces of neural networks have been of recent interest in the deep learning community both from a numerical and a theoretical perspective. Their optimization yields interesting examples of a high-dimensional non-convex problem, where counterintuitively gradient descent methods successfully converge to non-spurious minima. Practically, recent advancements in several applications have used insights on loss surfaces to justify their approaches. For instance, investigations have been made regarding regularizing the curvature of the loss surface to increase the robustness of trained models.

One interesting question about these non-convex loss surfaces is to what extent trained models, which correspond to local minima, are connected. Here, connection denotes the existence of a path between the models, parameterized by their weights, along which loss is nearly constant. There has been conjecture that such models are connected asymptotically, with respect to the width of hidden layers. Recently, this has been proven for rectified networks with one hidden layer.

When considering the connection between two neural networks, it is pertinent to consider what properties of the neural networks are intrinsic. Intuitively, there is a permutation ambiguity in the indexing of units in a given hidden layer of a neural network, and as a result, this ambiguity extends to the network weights themselves. Thus, there are numerous equivalent points in model space that correspond to a given neural network. This creates weight symmetry in the loss landscape. It is possible that the minimal loss paths between a network and all networks equivalent to a second network could be quite different. If the best path among this set is not considered, there might be a failure to see to what extent models are intrinsically connected. Advantageously, one or more embodiments provide a technique for more consistent model interpolation/optimal connection finding by investigating the effect of weight symmetry in the loss landscape. The analyses and results provide insight into the geometry of level sets of the loss surfaces of deep networks that are often hard to study theoretically.

One or more embodiments provide techniques to formalize this problem, and apply a proximal alternating minimization (PAM) scheme to split the problem into iteratively optimizing the permutation of the second model weights and optimizing the curve parameters. Convergence of this scheme to a local critical point is proven for feed-forward neural networks which are piece-wise analytic functions and continuously differentiable. Furthermore, considering known neuron alignment techniques and the aforementioned PAM framework, one or more embodiments provide a heuristic for approximating the optimal permutation for learning aligned curves connecting networks up to weight symmetry. Even further, experimental results are provided for three datasets and four architectures affirming that more optimal curves can be learned faster with neuron alignment. We have found that this aligned permutation is close to a locally optimal permutation that PAM converges to under the same initialization. For learned curves connecting adversarial robust models, we have found that the robust loss barrier can be greatly reduced with alignment, making it possible to find more accurate robust models on the path.

Consider approaches for loss optima connectivity and neuron alignment.

Loss Optima Connectivity. To learn the minimal loss path connecting two N-dimensional neural networks, θ₁ and θ₂, the curve finding approach introduced in Garipov, T., Izmailov, P., Podoprikhin, D., Vetrov, D. P., and Wilson, A. G., Loss surfaces, mode connectivity, and fast ensembling of dnns, in Advances in Neural Information Processing Systems, pp. 8789-8798, 2018, can be employed, for example. Search for the path, r: [0; 1]→R^{N}, that connects the two models while minimizing the average of the loss function, [symbol] along the path. This problem is formalized in equation (1):

$${r}^{*} = arg {min}_{r} \frac{{\int }_{t ∈ [ 0 , 1 ]} ℒ ( r ( t ) ) ‖ {r}^{′} ( t ) ‖ dt}{{\int }_{t ∈ [ 0 , 1 ]} ‖ {r}^{′} ( t ) ‖ dt} \\ subject to r ( 0 ) = {θ}_{1} , r ( 1 ) = {θ}_{2} . \qquad ( 1 )$$

For tractability, r* can be approximated by a parameterized curve r_{φ}, where φ denotes the curve parameters. For instance, as described below, one or more embodiments employ the quadratic Bezier curve. Computationally, an arclength parameterization, that is ∥r′(t)∥=1 for all t, is assumed to make optimization more computationally feasible. If the endpoint networks are global minima and a flat loss path exists, then the optimal objective of equation (1) is unchanged. Algorithm 2 discussed below addresses how to solve this optimization problem computationally. For clarity, r_{φ} denotes the curve on the loss surface between two networks while r_{φ}(t) is a point on that curve which is a neural network.

Neuron Alignment. The skilled artisan will be familiar with the neuron alignment framework from, for example, Li, Y., Yosinski, J., Clune, J., Lipson, H., and Hoperoft, J. E., Convergent learning: Do different neural networks learn the same representations, in ICLR 2016. Given input d drawn from the input data distribution D, let X_{l,i,:}⁽¹⁾(d)∈ [symbol] ^{k}, represent the activation values of channel i in layer l of network θ₁, where k is the number of units in the channel. As an example, a channel could correspond to one unit in a hidden state or one filter output by a convolutional layer, where k would be l or the number of pixels in the filter respectively.

Given networks, θ₁ and θ₂, define the channel-wise mean for θ₁ in equation (2), with standard deviation defined analogously. Also define the cross-correlation matrix, Cₗ^{(1,2)}, denoting the cross-correlation between each channel in θ₁ and θ₂ in layer l.

$${μ}_{l , i}^{( 1 )} = {𝔼}_{X \sim D} [ \frac{1}{k} {\sum }_{a = 1}^{k} {X}_{l , i , a}^{( 1 )} ] \\ {C}_{l , i , j}^{( 1 , 2 )} = \frac{{𝔼}_{X \sim D} [ {\sum }_{a = 1}^{k} ( {X}_{l , i , a}^{( 1 )} - {μ}_{l , i}^{( 1 )} ) ( {X}_{l , j , a}^{( 2 )} - {μ}_{l , j}^{( 2 )} ) ]}{k {σ}_{l , i}^{( 1 )} {σ}_{l , j}^{( 2 )}} \qquad ( 2 )$$

To align the activations in layer l between networks θ₁ and θ₂, the neuron alignment algorithm maximizes the sum of cross-correlation between aligned activations. Equivalently, this finds the permutation, Pₗ, that maximizes the trace of Pₗ^{T}C_{l,:,:}^{(1,2)}, which is an instance of the linear assignment problem. This optimization model is formalized in equation (3) below, where Kₗ represents the index set of activations in layer l. The skilled artisan will have a background familiarity with the assignment problem, from, for example, Burkard, R. E. and Cela, E., Linear assignment problems and extensions, in Handbook of combinatorial optimization, pp. 75-149, Springer, 1999.

$${max}_{{P}_{l}} trace ( {P}_{l}^{T} {C}_{l , : , :}^{( 1 , 2 )} ) ; {P}_{l}^{T} {P}_{l} = I , {p}_{l} ∈ \{ 0 , 1 \} \qquad ( 3 )$$

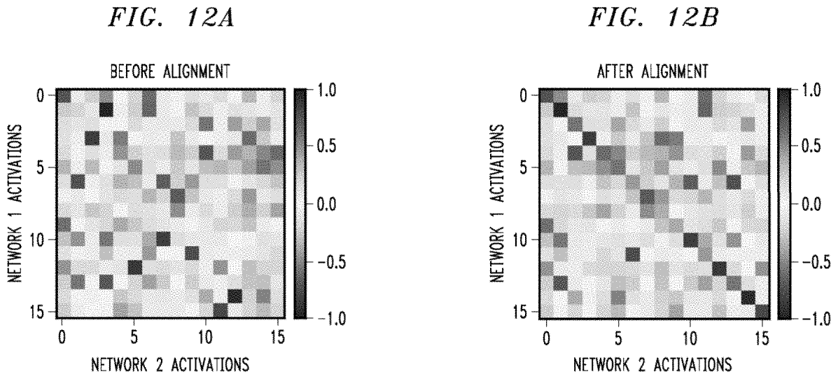

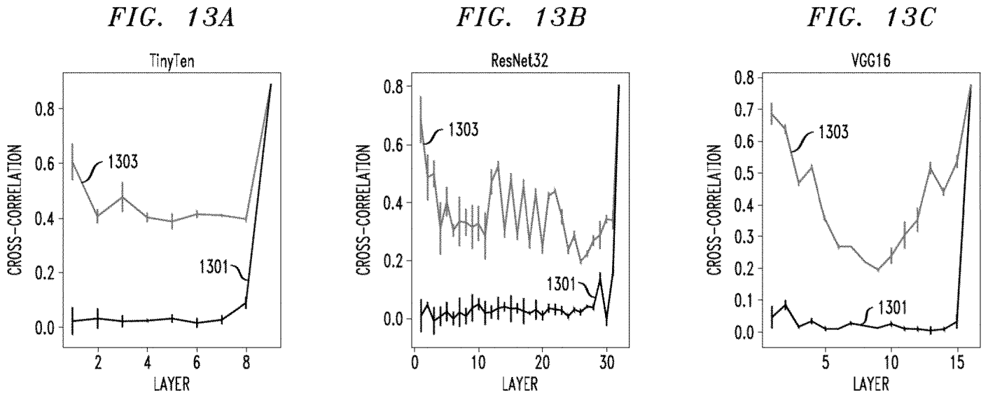

The alignment technique is visualized in FIGS. 12, 12B, 13A, 13B, and 13C.

FIGS. 12A and 12B display the cross-correlation matrix for the TinyTen network and CIFAR100 dataset. FIG. 12A uses the original indices of the second network, while FIG. 12B uses the re-indexing of the second model consistent with alignment to the first. Note the diagonal of FIG. 12B is much more positive than FIG. 12A, which implies a meaningful correspondence between aligned units. FIGS. 13A, 13B, and 13C display the mean cross-correlation at each layer between corresponding neurons. These figures also show the standard deviation of this signal over a set of three network pairs. With this correlation signature being consistent over different pairs and being increased highly with alignment, there is confidence that some subset of highly correlated features are being matched. The mean cross-correlation between corresponding units is shown for each layer before and after alignment. The quality of the correspondence between the average pair of units at each layer can be strongly improved through alignment. Curves 1301 are before alignment and curves 1303 are after alignment.

Connectivity with Weight Symmetry. Consider the idea of weight symmetry in a neural network. θ₁ this a neural network on the loss surface parameterized by its weights. A permutation Pₗ is in Π_{|Kl|}, the set of permutations on Kₗ, the index set of channels in layer l. For simplicity consider an L layer feed-forward network with activation function σ, weights {Wₗ}ₗ₌₁^{L}, and input X₀. Then the weight permutation ambiguity becomes clear when the following set of permutations are introduced to the feedforward equation:

Y:=W_{L}P_{L-1}^{T}∘σ∘P_{L-1}W_{L-1}P_{L-2}^{T}∘ . . . ∘σ∘P₁W₁X₀ (4)

Then, define the network weight permutation P as the block diagonal matrix, blockdiag(P₁, P₂, . . . , P_{L-1}). Additionally, Pθ denotes the network parameterized by the weights [P₁W₁, P₂W₂P₁^{T}, W_{L}P_{L-1}^{T}]. Note that permutations P₀ and P_{L} are omitted, as the input and output channels of neural networks have a fixed ordering, so they correspond to the identity I. Without much difficulty this framework generalizes for more complicated architectures. This is discussed below for residual networks.

Curve Finding up to Symmetry. From equation (4), it becomes clear that the networks θ₁ and Pθ₂ share the same structure and intermediate outputs up to indexing. Taking weight symmetry into account, the optimal curve can be found connecting two networks up to symmetry with the model in equation (5).

$${min}_{ϕ , P} {𝔼}_{t \sim U} [ ℒ ( {r}_{ϕ} ( t ) ) ] \\ \begin{matrix}subject to {r}_{ϕ} ( 0 ) = {θ}_{1} , {r}_{ϕ} ( 1 ) = P {θ}_{2} , \\ P = block diag ( {P}_{1} , {P}_{2} , … , {P}_{L - 1} ) \\ {P}_{l} ∈ {\prod }_{\vert {K}_{l} \vert} for l ∈ \{ 1 , 2 , … , L - 1 \}\end{matrix} \qquad ( 5 )$$

Proximal Alternating Minimization as A Framework. A framework is introduced to solve the generalized problem in equation (5). Theoretically, this problem is fairly complicated and hard to analyze. Numerically, approaching the problem directly with first order methods could be computationally intensive as it will typically be required to store gradients of φ and P simultaneously. The problem can be more easily addressed using the method of proximal alternating minimization (PAM). The PAM scheme involves iteratively solving the two subproblems in equation (6). Here, let Q(φ, P) denote the objective function in equation (5). In a non-limiting example, only consider parameterized forms of r that satisfy the endpoint constraints for all φ and P.

$$\{ \begin{matrix}{P}^{k + 1} = {argmin}_{P} & Q ( {ϕ}^{k} , P ) + \frac{1}{2 {ν}_{P}} {‖ P - {P}^{k} ‖}_{2}^{2} \\ such that & {P}_{l} ∈ {\prod }_{\vert {K}_{l} \vert} for l ∈ \{ 1 , … , L - 1 \} \\ & P = block diag ( {P}_{1} , … , {P}_{L - 1} ) \\ {ϕ}^{k + 1} = {argmin}_{ϕ} & Q ( ϕ , {P}^{k + 1} ) + \frac{1}{2 {ν}_{ϕ}} {‖ ϕ - {ϕ}^{k} ‖}_{2}^{2}\end{matrix} \qquad ( 6 )$$

Computing the unaligned curve is equivalent to solving the PAM scheme with a very small value of v_{P}. In fact, it is possible to prove local convergence results for a certain class of networks.

Theorem (convergence): Let {φ^{k+1}, P^{k+1}} be the sequence produced by equation (6). Assume that r_{φ}(t) corresponds to a feed-forward neural network with activation function a for t∈[0, 1]. Assume that [symbol] r_{φ}, and σ are all piece-wise analytic functions in C¹ and locally Lipschitz differentiable in φ and P. Lastly, assume that the input data is bounded and the norm of the network weights are constrained to be bounded above. Then the following statements hold:

$$\begin{matrix}Q ( {ϕ}^{k + 1} , {P}^{k + 1} ) + \frac{1}{2 {ν}_{ϕ}} {‖ {ϕ}^{k + 1} - {ϕ}^{k} ‖}_{2}^{2} + \frac{1}{2 {ν}_{P}} {‖ {P}^{k + 1} - {P}^{k} ‖}_{2}^{2} \leq Q ( {ϕ}^{k} , {P}^{k} ) , ∀ k \geq 0 & 1. \\ \{ {ϕ}^{k} , {P}^{k} \} converges to critical point of Q ( ϕ , P ) & 2.\end{matrix}$$

A proof of the above is provided below.

Neuron Alignment as An Initialization. In spite of convergence guarantees, PAM still typically requires a good initialization as the loss landscape is nonconvex. This is pertinent for avoiding convergence to non-global optima. Conceptually, neuron alignment is able to match subsets of similar feature representations. Thus, it is believed that the permutation on the network weights induced by neuron alignment can be meaningful enough to provide a good initialization of P.

In one or more embodiments, solve the linear sum assignment problem formulated in equation (3) using the Hungarian algorithm. Algorithm 1 in FIG. 14 summarizes the process for efficiently computing a permutation of the network weights from neuron alignment. For an L layer network with a maximum layer width of M, compute P using a subset of the training data. Then the cost of computing the cross-correlation matrices for all layers is dominated by the forward propagation through the network to accumulate the activations. The running time needed to compute all needed linear assignments is [symbol] LM³), with storage [symbol] LM). This is on the order of the running time associated with one iteration of forward propagation. Then neuron alignment is relatively cheap as the time complexity of computing curves using neuron alignment is on the same order as traditional curve finding. These different curves are referred to herein as aligned and unaligned.

Experiments

Datasets. We trained neural networks to classify images from CIFAR10 and CIFAR100, as well as STL10. The default training and test set splits are used for each dataset. The loss function is the cross-entropy loss on the SoftMax of the logits output by the networks. 20% of the images in the training set are used for computing alignments between pairs of models. The data was augmented using color normalization, random horizontal flips, random rotation, and random cropping to prevent models from overfitting.

Architectures Four different model architectures were used. The table of FIG. 15 contains relevant properties of these architectures. The first architectures considered were the TinySix and TinyTen models. TinyTen is a narrow 10 layer convolutional neural network that uses batch-normalization, rectified linear unit (ReLU) activations, and global average pooling. TinySix is equivalent to TinyTen with layers 2, 4, 5, and 7 removed. These are useful models for concept testing and permit gaining insight to networks that are under-parameterized. Also included is ResNet32, to understand the effect of skip connections on curve finding with alignment. VGG16-BN is the third architecture that was considered in our experiments. VGG16 has significantly more parameters compared to other models. This set of architectures was chosen for its varying properties and because of prevalence in related literature. The average accuracy along the curve with standard deviation is reported for each combination of dataset, network architecture, and curve class. This shows that aligned curves not only outperform the unaligned curves which do not consider the permutation ambiguity, they perform as well as the PAM curves which learn a locally optimal permutation. Note that aligned accuracies are typically as high as the trained model accuracies used as endpoints. Additionally, properties for each architecture are also listed.

All models used as curve endpoints were trained using stochastic gradient descent. In our experiments, we set a learning rate of 1E-1 that decays by a factor of 0.5 every 20 epochs. Weight decay of 5E-4 was used for regularization. Each model was trained for 250 epochs, and all models were seen to converge. This training scheme produced models of comparable accuracy to those in related literature, so we omitted fine-tuning hyperparameters. Models were trained on NVIDIA Tesla K80 GPUs.

Quadratic Bezier curves. All curves were parameterized as quadratic Bezier curves. Bezier curves are popular in computer graphics as they can be defined by their control points. The current study refers to endpoint models as θ₁ and θ₂ as well as the control point, θ_{c}. Then r is defined in equation (7) with θ_{c} as the learnable parameter in φ.

r_{ϕ}(t)=(1−t)²θ₁+2(1−t)tθ_{c}+t²θ₂ (7)

Training Curves. For each architecture, train 12, 6, and 6 different models using different random initializations for CIFAR10, CIFAR100, and STL10 respectively. Thus, there are 6 or 3 independent model pairs for a dataset. Learn four classes of curves that are solutions to:

Unaligned: algorithm 2 (see FIG. 49) for θ₁ and θ₂

PAM Unaligned: equation (6) for θ₁ and θ₂ with P⁽⁰⁾=I

PAM Aligned: equation (6) for θ₁ and θ₂ with P⁽⁰⁾=P_{Al}

Aligned: algorithm 2 for θ₁ and P_{Al}θ₂ where P_{Al} denotes the permutation learned by neuron alignment (algorithm 1).

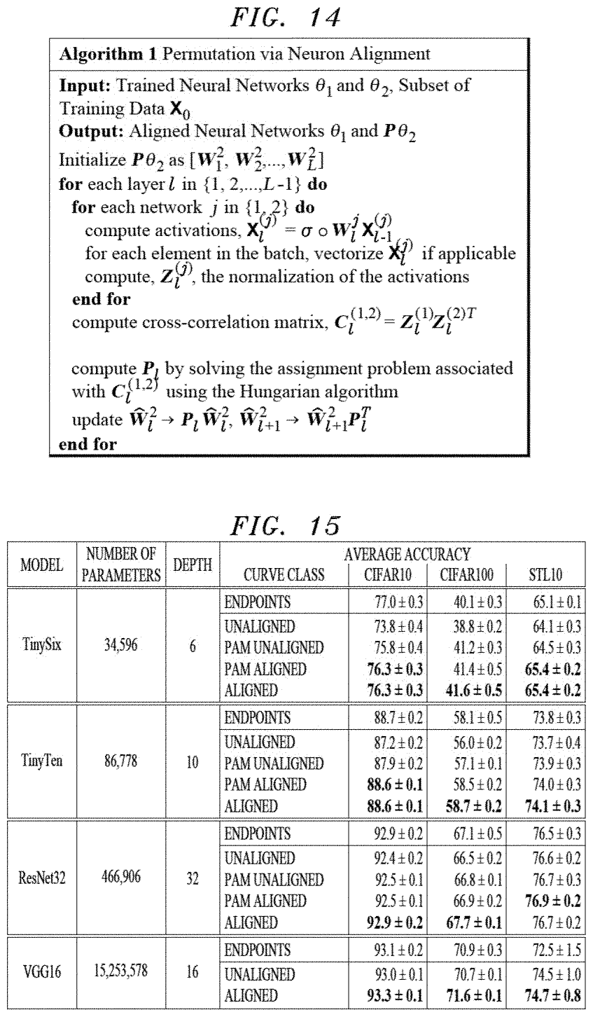

PAM curves were learned for all architectures except VGG16, as its size made this computationally prohibitive. Two sets of each curve class were trained. One set involves the curves learned when the random seed for curve finding is fixed for all model pairs. The other set includes the curves learned when the random seed is different for each model pair. We have found that the learned curves for different seeds are similar up to re-indexing the endpoints. For FIGS. 16A-18C and 20A-22C, the first set of curves were used so that interesting geometric features on the loss surface were not averaged out. For tables and other figures, the second more general set of curves were used.

Neuron Alignment

The effects of using neuron alignment as a heuristic for curve finding up to symmetry were investigated. That is, determine some weight permutation PAl and then find the curve between networks θ₁ and P_{Al}θ₂. The unaligned and aligned curves were both trained for 200 epochs using stochastic gradient descent with an annealing learning rate. The training of these curves shares the same hyperparameters as the training of the individual models.

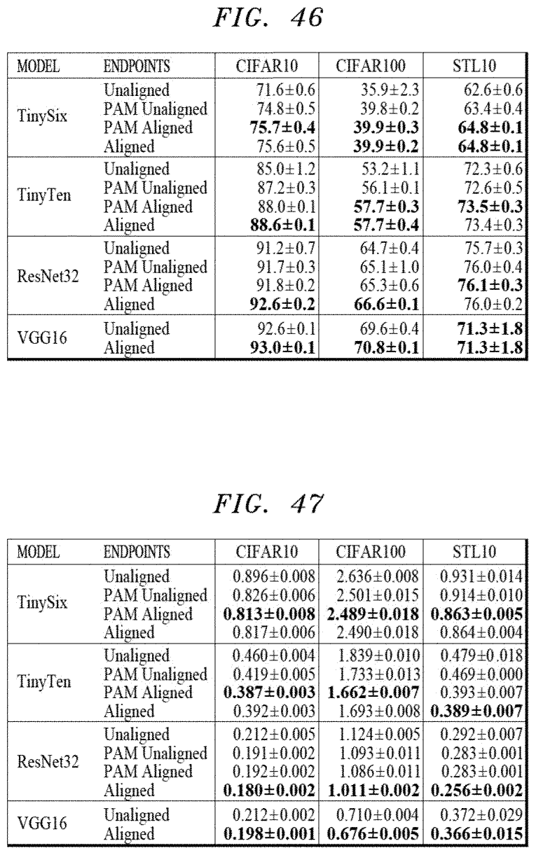

The test accuracy can be seen for each dataset and curve class in the table of FIG. 15. Clearly, the aligned curves outperform the unaligned curve. In many cases, the average accuracy along the aligned curves in comparable to the trained models used as endpoints. The table of FIG. 46 contains the minimum accuracy along the curve with standard deviation for each combination of dataset, network architecture, and curve class., indicating that aligned curves do not suffer from the same generalization gap that unaligned curves are prone to. Finally, the table of FIG. 47 contains the training loss with standard deviation for each combination at convergence. Overall, it is clear that the strongest gains from using alignment are in the case of under-parameterized networks. As seen in the table of FIG. 15, the largest increase in performance is for TinySix on CIFAR100 while the smallest gain is made for STL10 on VGG16.

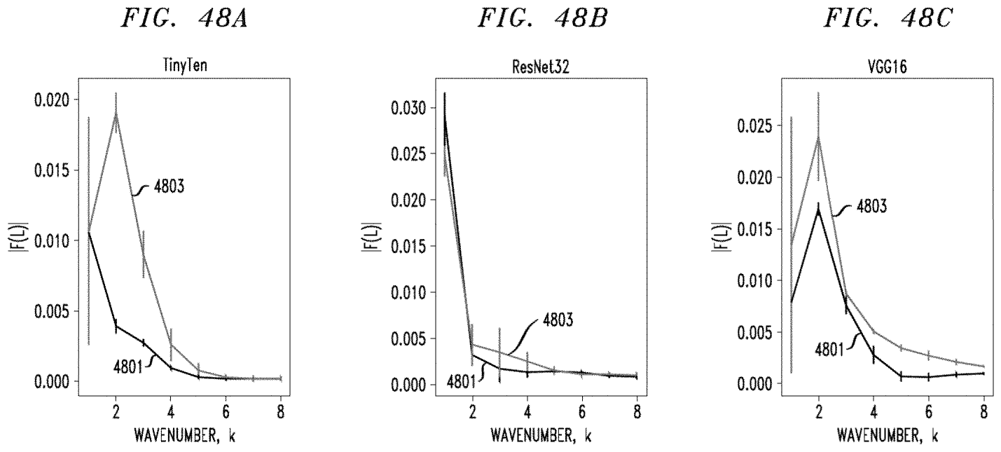

FIGS. 48A-48C show Fourier transform of CIFAR100 loss curve. Notice that the absolute value of the transform is lower for the aligned case 4801 at higher modes/wavenumbers. In spectral terms, this shows that the average aligned curve is less oscillatory than the unaligned curve 4803. This is a rigorous way to measure the smoothness of a curve.

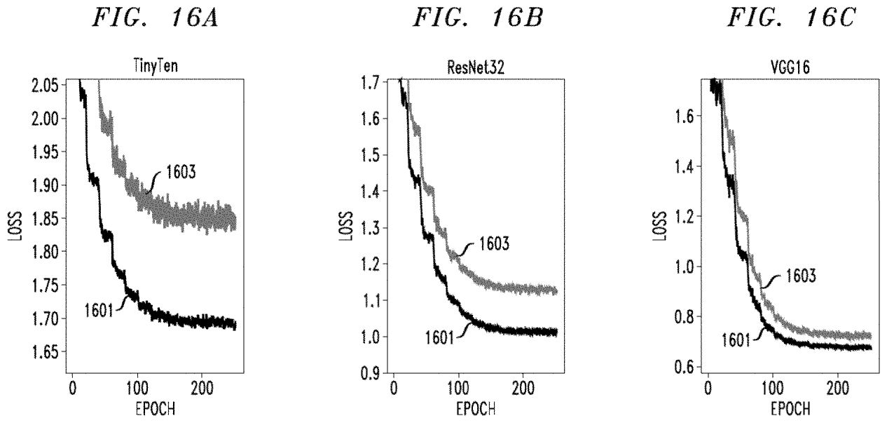

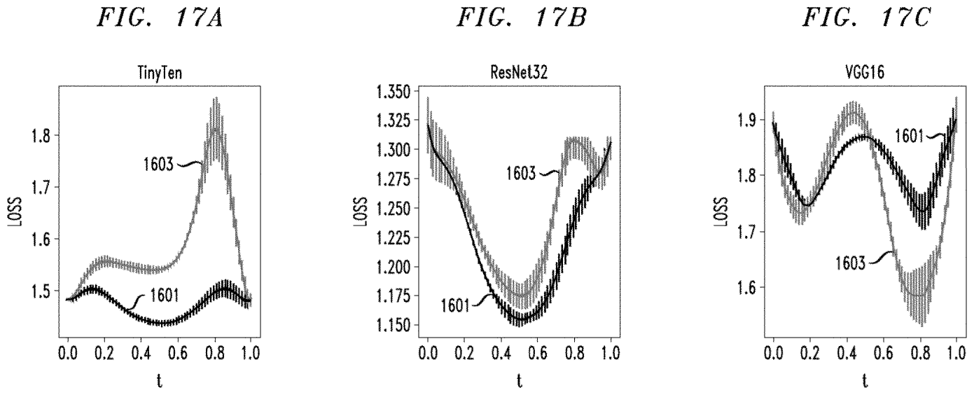

The test loss and accuracy along the learned curves for CIFAR100 are shown in FIGS. 16A-18C. It can be seen that the accuracy at each point along the aligned curve 1601 exceeds that of the unaligned curve 1603, while the loss along the curve is also smoother with neuron alignment. Noteworthy is the prominent presence of the accuracy barrier along the unaligned curve around t at 0.8 for all models. This accuracy barrier corresponds to a clear loss barrier for Tiny-10 and ResNet32. In contrast, for VGG16 there is lowest loss at this point on the unaligned curve with worse generalization performance. Overall, loss along the aligned curves varies more smoothly and has better generalization. Re FIGS. 16A-16C, the training loss for learning the quadratic Bezier curve between model endpoints on CIFAR100 is shown. These are compared for aligned and unaligned curves. The training of aligned curves converges to lower loss value in less epochs than for unaligned curves. Re FIGS. 17A-18C, test loss/accuracy along these curves is shown. Aligned curves generalize better and do not suffer from large drops in accuracy typical for unaligned curves.

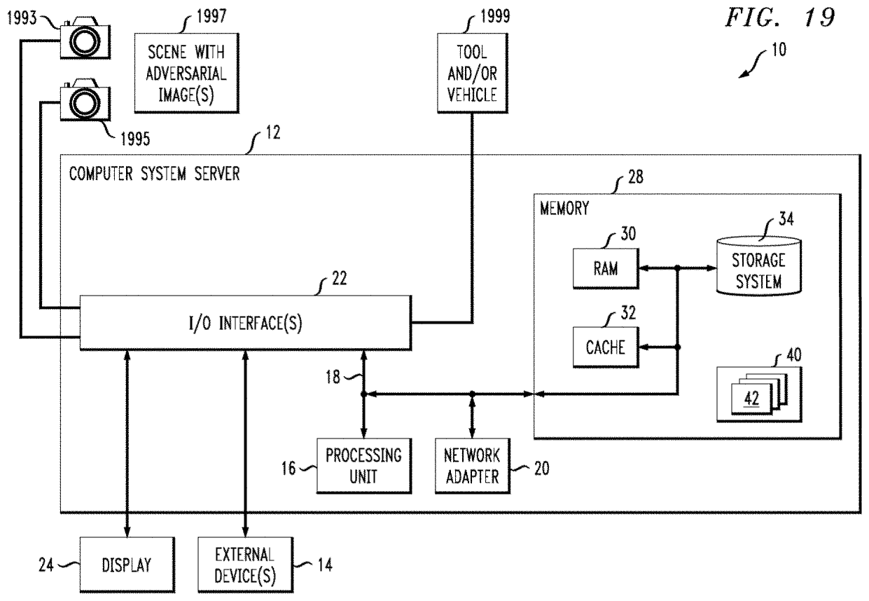

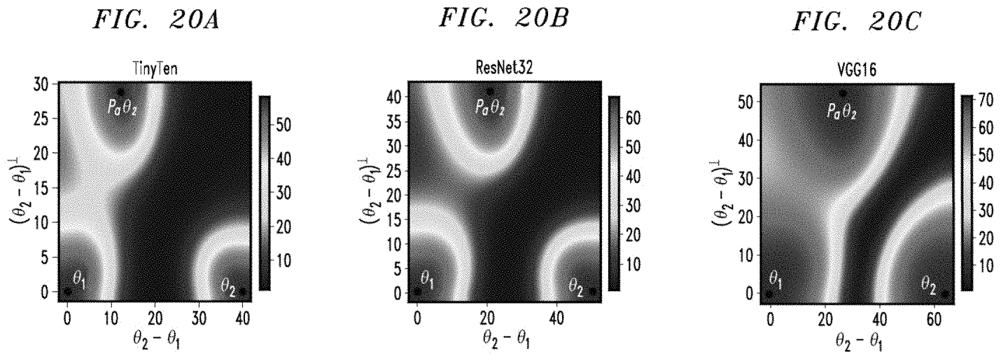

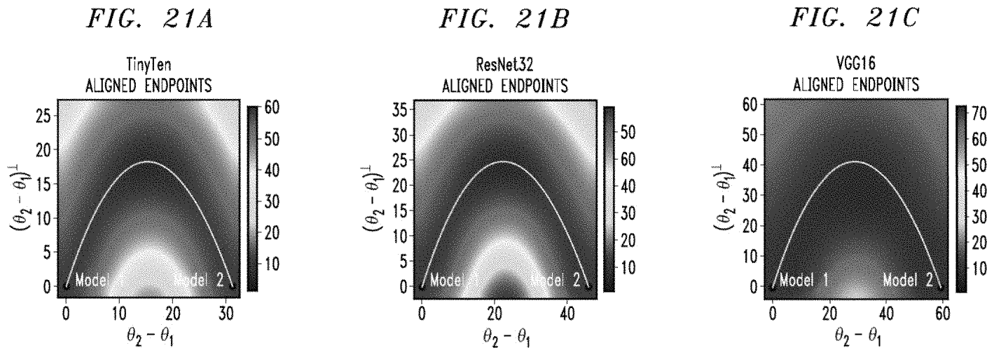

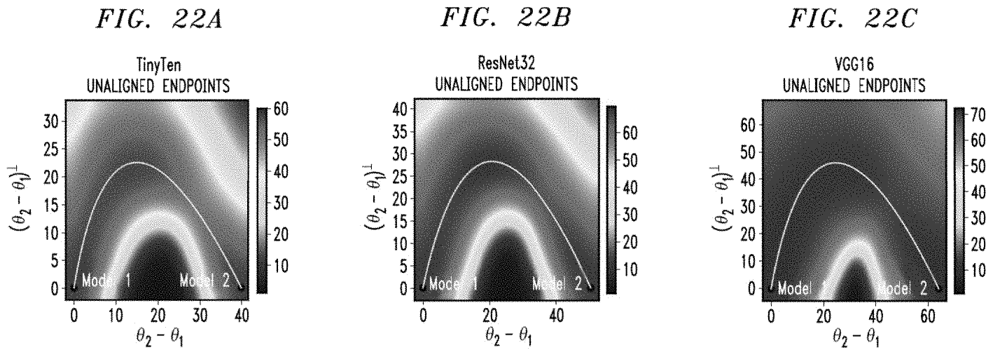

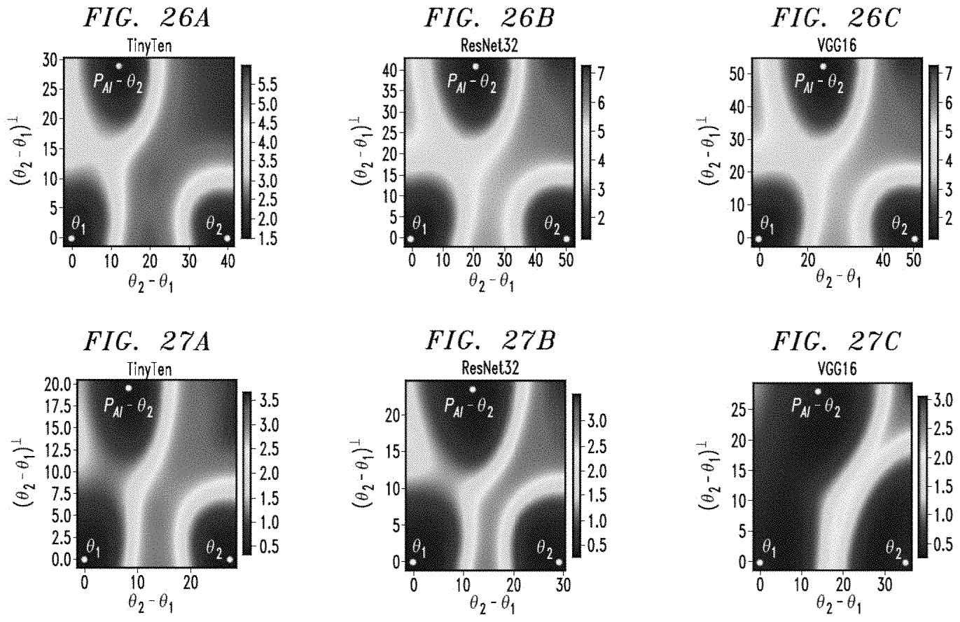

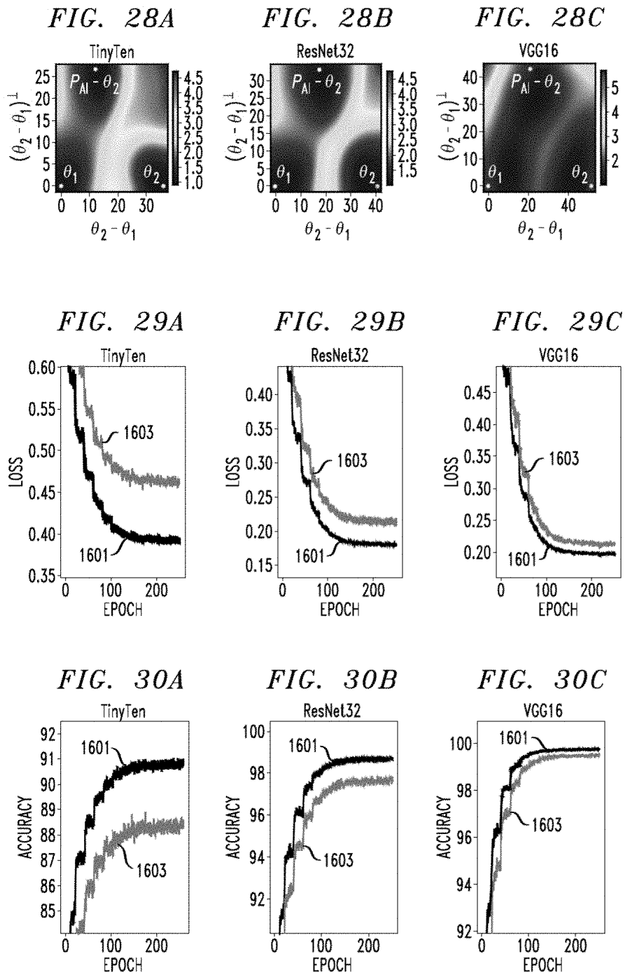

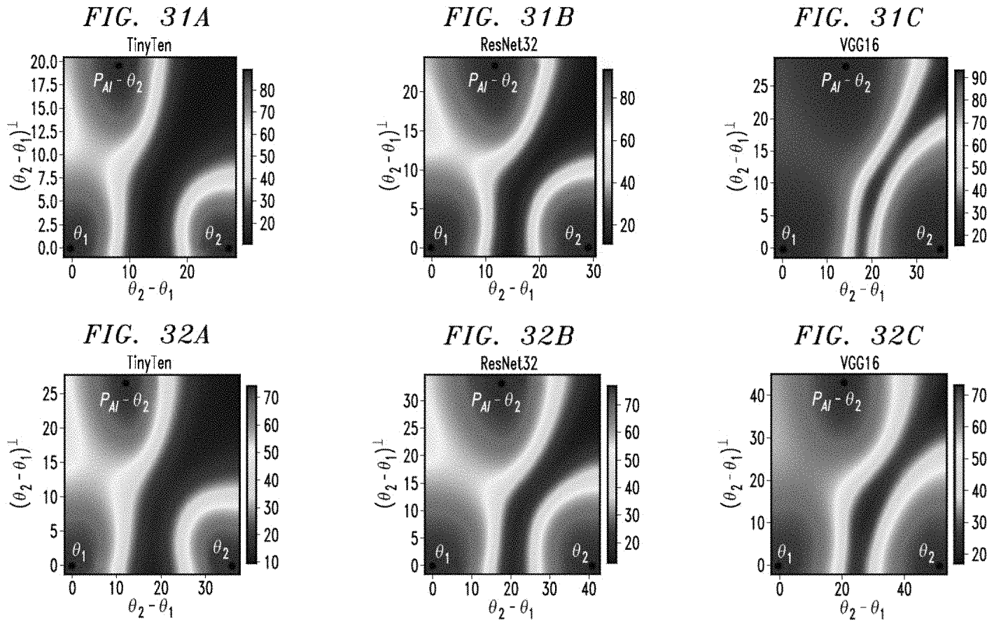

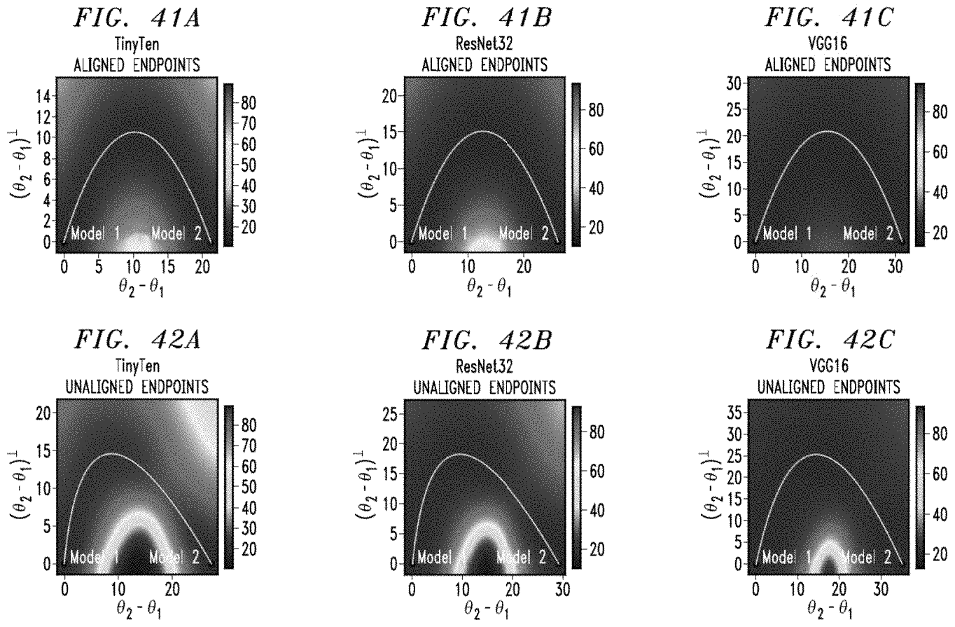

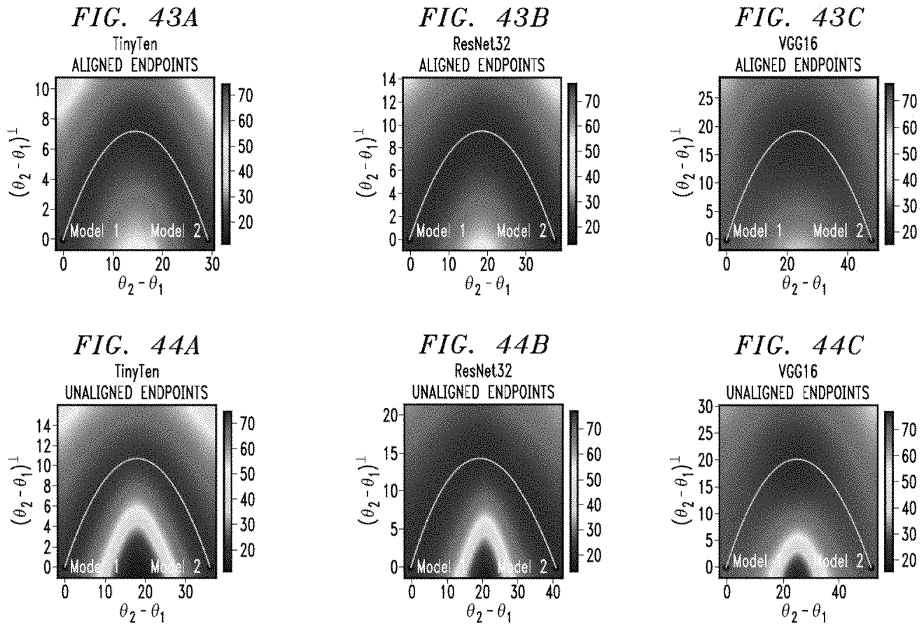

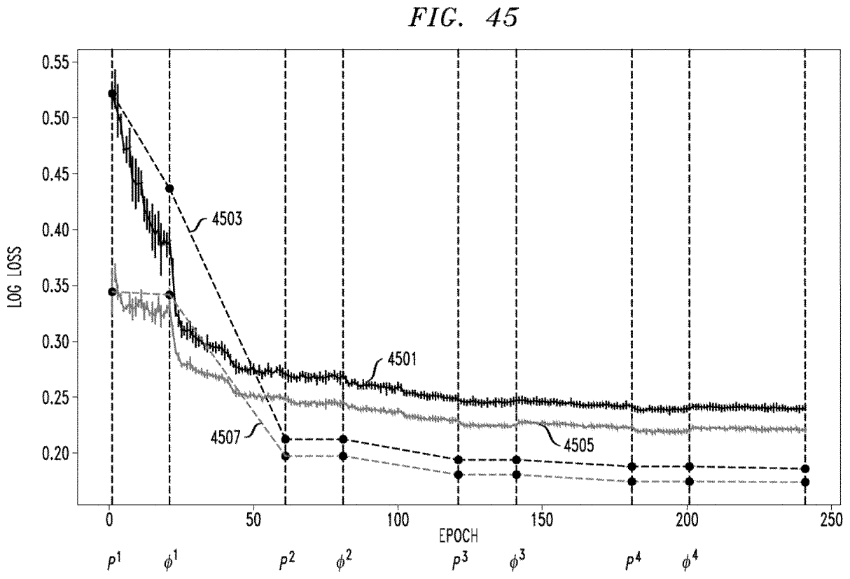

FIGS. 20A-20C display the planes which contain the initializations for curve finding. Test accuracy on CIFAR100 is shown across the plane containing θ₁, θ₂, and Pₐₗθ₂, where Pal is determined using neuron alignment. This plane contains the two different initializations used in the curve finding experiments. The default initialization, θ₂−θ₁, and the aligned initialization, Pₐₗθ₂−θ₁. This shows that the aligned initialization is notably better. It is clear that the aligned initialization has better objective value. This can also be seen for the other datasets in FIGS. 31A-32C (test accuracy on plane containing θ₁, θ₂, and Pₐₗθ₂). The planes containing the learned curves are displayed in FIGS. 21A-22C, which depict test accuracy on CIFAR100 across the plane containing the Bezier curve, r_{φ}(t). These are the planes containing θ₁, Pθ₂, and θ_{c}, although the control point is out of bounds of the figure. The axis is determined by Gram-Schmidt orthonormalization. The loss displayed on the planes containing the linear initializations and the Bezier curves (θ₁, θ₂, and Pₐₗθ₂) can be seen in FIGS. 26A-28C. The aforementioned plots are for CIFAR100. Plots for the other datasets correspond to FIGS. 41A-44C 40C (Test accuracy on plane containing learned curve, r_{φ}(t)) and 35A-40C (Test loss on plane containing learned curve, r_{φ}(t)).

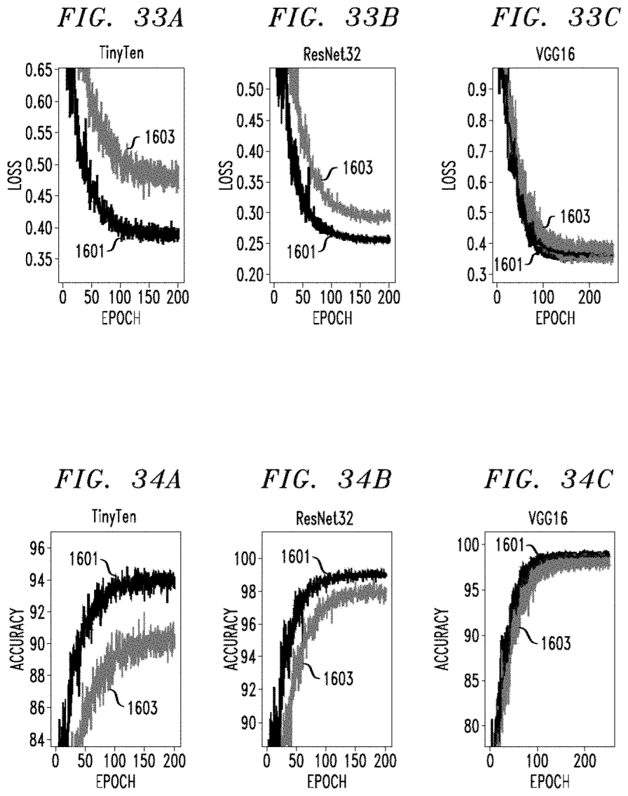

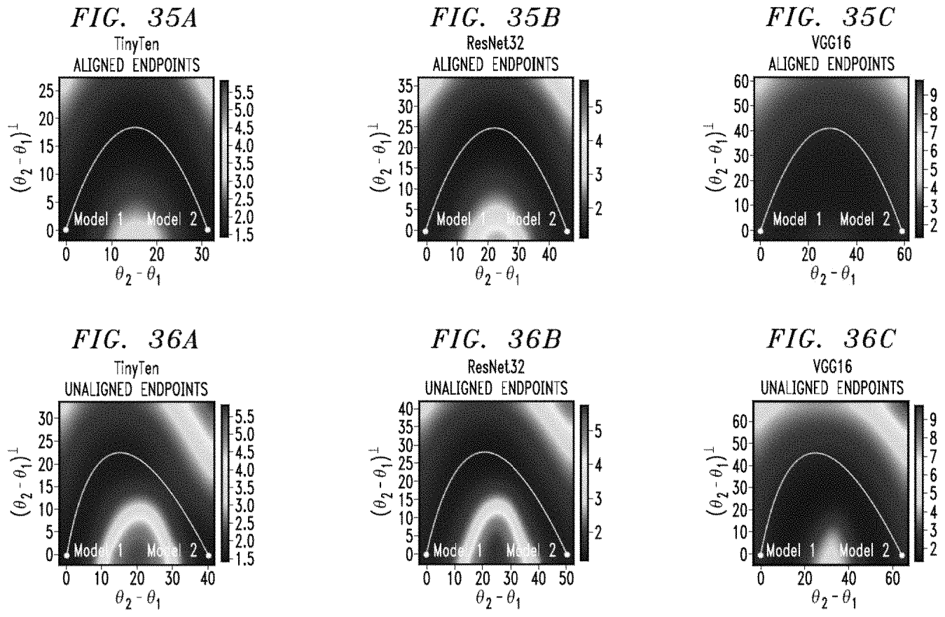

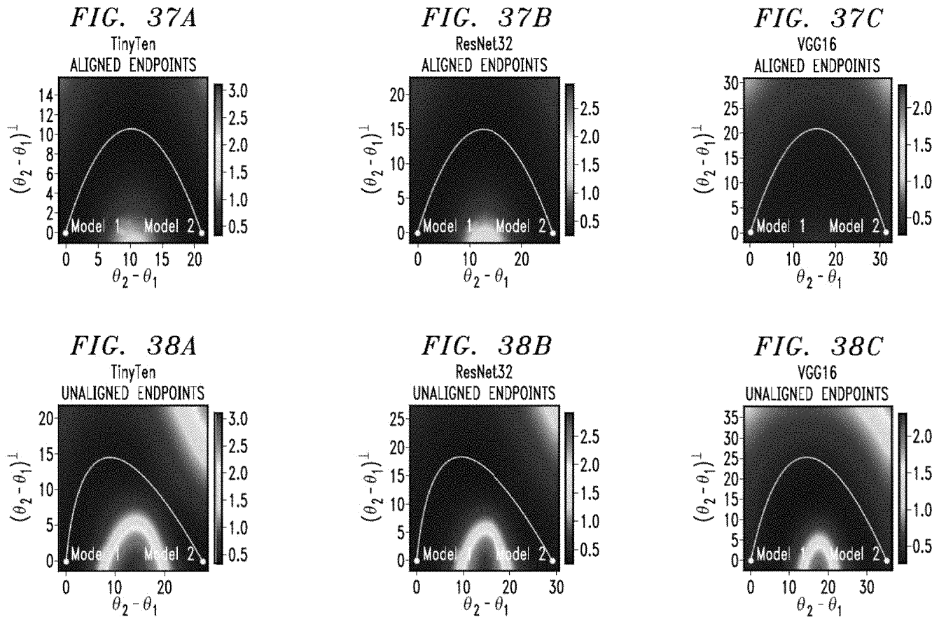

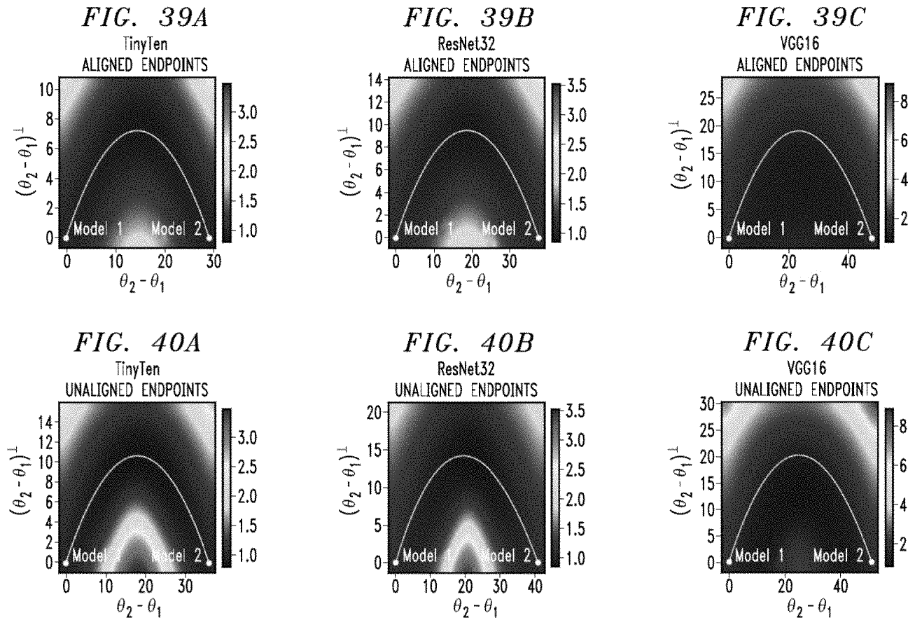

Practically, the neuron alignment heuristic for determining the permutation P may be enough and avoids more complicated optimization. Note the relative flatness of the accuracy along the aligned curves in FIGS. 16A-18C. Additionally, the plots in FIGS. 16A-16C indicate much faster convergence when learning φ using neuron alignment, which is believed to be quite significant. For example, the aligned curve takes one hundred epochs less to achieve the training accuracy that the unaligned curve converges to, when TinyTen is used on CIFAR100. Even for VGG16, the aligned curve reaches the milestone forty epochs earlier. FIGS. 29A-30C (FIGS. 29A-29C training loss/FIGS. 30A-30C accuracy while learning the curve between two CIFAR10 models) and 33A-34C (FIGS. 33A-33C training loss/FIGS. 34A-34C accuracy while learning the curve between two STL10 models) display these curves for the additional datasets (aligned curves 1601, unaligned curves 1603).

Further insight into why neuron alignment works is provided below, considering how the alignment is preserved along the learned curve. Results show that (1) the midpoints of the unaligned curves are highly aligned to each endpoint, even though the endpoints themselves are weakly aligned at best; and (2) Curve finding is essentially smoothly interpolating similar feature representations. Sensibly, neuron alignment of the endpoints makes this task easier.

Proximal Alternating Minimization. Proximal alternating minimization provides a comprehensive formulation for learning the weight permutation P directly, coupled with some convergence guarantees. We have found that curves learned using PAM perform better than the unaligned curves as seen in the table of FIG. 15. As was the case for the aligned curves, this performance gain is more notable in under-parameterized models. Notably, the aligned curves perform comparably to PAM aligned. This indicates that PAl is already close to the locally optimal permutation when PAl is chosen as the initialization for PAM. Additionally, the performance gain of PAM Aligned over PAM Unaligned shows that this permutation is not easy to learn when P⁽⁰⁾ is not necessarily close. Then training aligned curves is an inexpensive way to approximate the solution to a rigorous optimization method with good initialization.

To learn each PAM curve, perform four iterations of PAM. The permutation subproblem entails 20 epochs of projected stochastic gradient descent to the set of doubly stochastic matrices. This is done as the set of doubly stochastic matrices is the convex relaxation of the set of permutations. This projection is accomplished through twenty iterations of alternating projection of the updated permutation to the set of nonnegative matrices and the set of matrices with row and column sum of one. After the twenty epochs of PGD, each layer permutation is projected to the set of permutations, Π_{|Kl|}. The curve parameter subproblem, which optimizes θ_{c} from equation (8), entails 40 epochs of SGD. The same hyperparameters are used as in training the endpoint models. The learning rates are annealed with each iteration of PAM. This training can be seen for CIFAR100 in FIG. 45. Note PAM unaligned training 4501, PAM unaligned test 4503, PAM aligned train 4505, and PAM aligned test 4507. FIG. 45 shows Log loss over a run of the proximal alternating minimization scheme on TinyTen for CIFAR100. The scheme includes twenty epochs of projected SGD to solve the permutation subproblem, followed by forty epochs of SGD to solve the curve parameter subproblem. Vertical lines denote the change in different subproblem iterations. This shows that neuron alignment provides a much better initialization for PAM, and this permutation initialization is close to being locally optimal.

New Findings for Mode Connectivity of Adversarial Robust Models

We have observed that aligning the features of two networks provides a benefit when learning a low loss curve connecting these networks. A recent topic of interest in the machine learning community has been learning robust models that can withstand adversarial attacks. As such, it was considered whether inventive results extend to robust models. Specifically, Projected Gradient Descent (PGD) attacks were considered. This is an evasion style attack that adds optimized l_{∞} bounded noise to an image to degrade accuracy. Security to evasion style attacks is important as they can be conducted without access to model parameters. Moreover, adversarial attacks can be used during model training to improve adversarial robustness, a method known as adversarial training. Herein the cross-entropy loss on the original samples and samples perturbed via PGD attacks are referred to as clean loss and robust loss respectively.

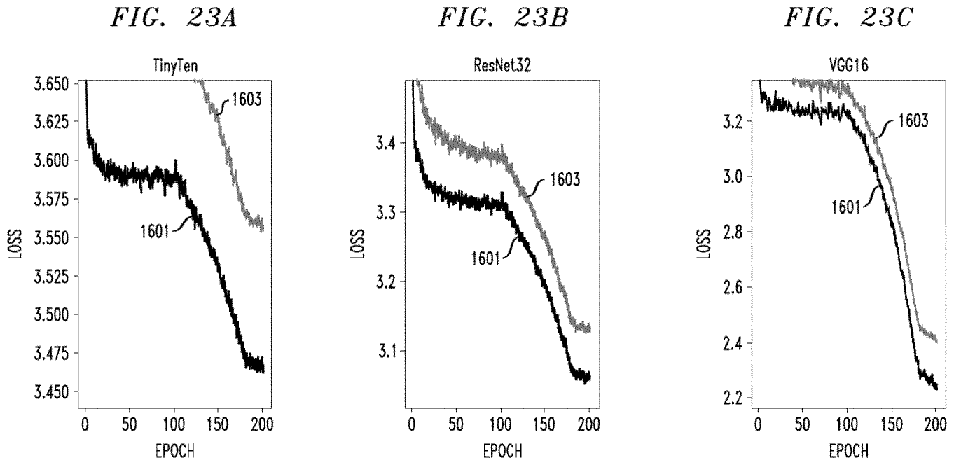

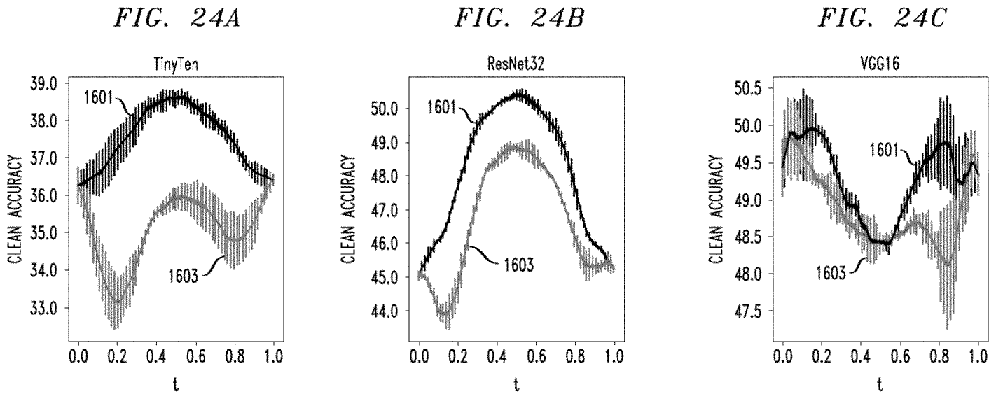

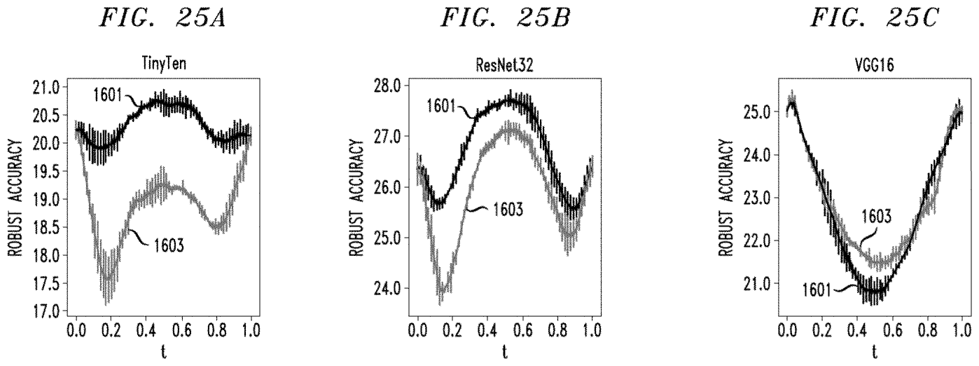

Alignment greatly reduces the robust loss barrier. FIGS. 23A-25C display the training loss and test accuracy of the learned robust curve between adversarially trained robust CIFAR100 models for three of the previously mentioned architectures (aligned curves 1601, unaligned curves 1603). FIGS. 24A-24C display standard test accuracy whereas FIGS. 25A-25C display the test accuracy of PGD adversarial examples. These networks and curves are trained with the same scheme as in Zhao, P., Chen, P.-Y., Das, P., Ramamurthy, K. N., and Lin, X, Bridging mode connectivity in loss landscapes and adversarial robustness, in International Conference on Learning Representations, 2020, with the initial learning rate to 1E-1. A pertinent point to consider is that the curve itself is trained to minimize robust loss, so the input undergoes PGD attack at each point along the curve. Re FIGS. 23A-23C, the robust training loss for learning the robust quadratic Bezier curve between robust model endpoints on CIFAR100 is depicted. By robust loss, this means that the input undergoes a PGD attack during evaluation. This shows that alignment decreases this training loss. Re FIGS. 24A-25C, Clean/Robust test accuracy along these curves is depicted. For TinyTen and ResNet32, it is clear that a more robust and accurate model can be found along the curve compared to the endpoints. VGG16 does not exhibit this behavior due to overfitting to attacks on the training data.

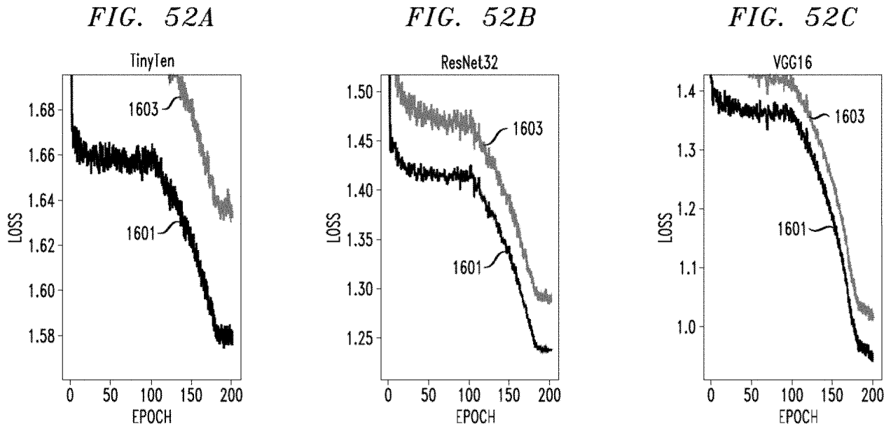

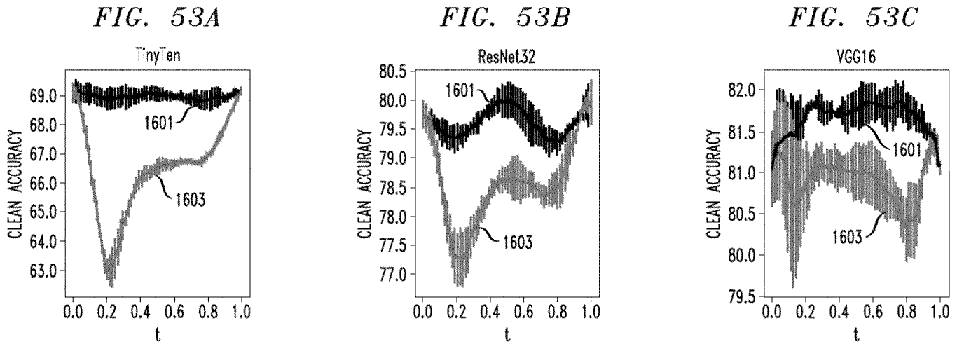

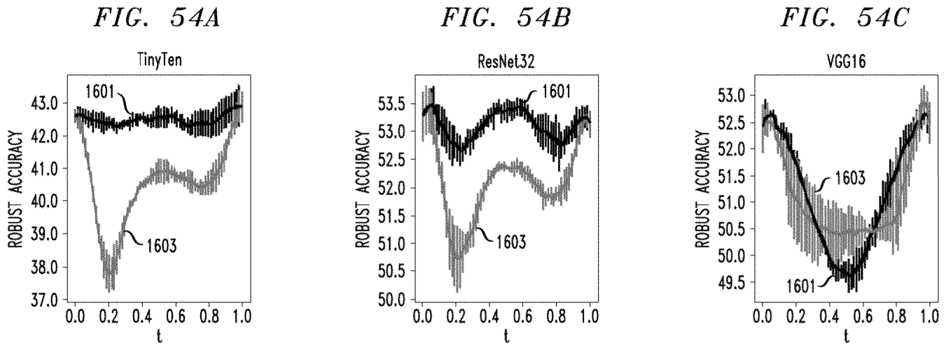

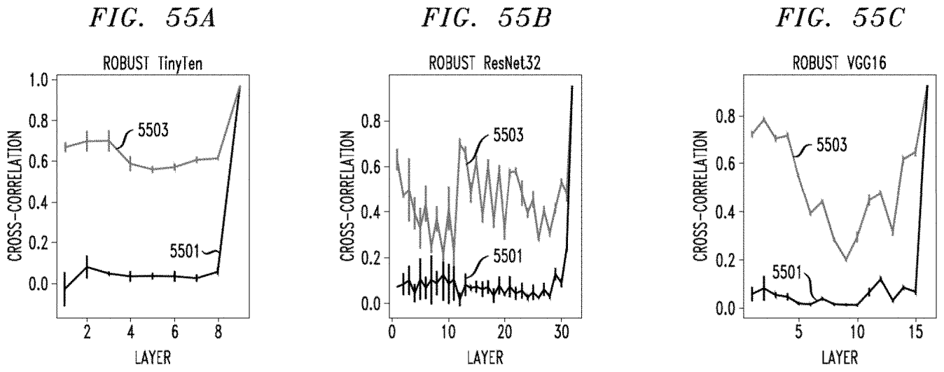

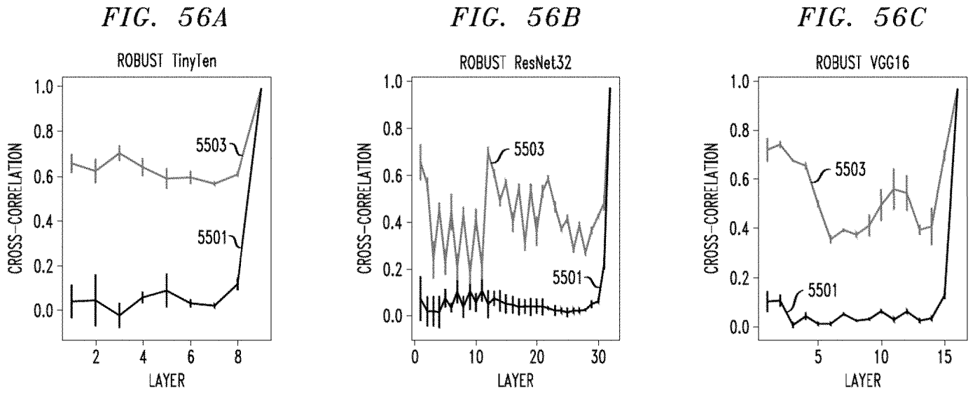

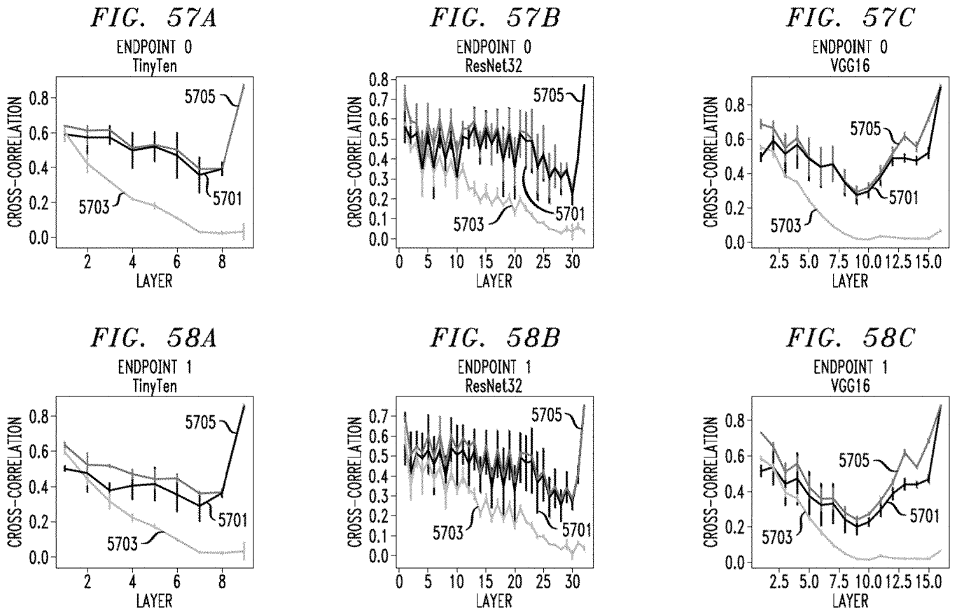

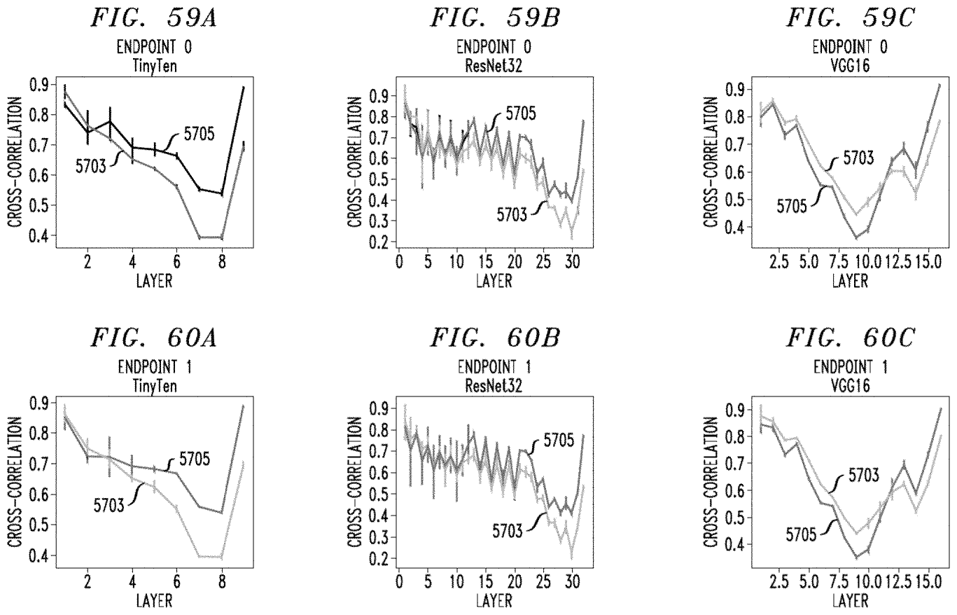

For the robust curve learned between two unaligned robust models, barriers were encountered both in clean accuracy and robust accuracy. As in FIGS. 16A-18C, these accuracy barriers appear to correspond with barriers in loss, where plots of robust loss along these curves can be found in FIGS. 50A-51C (aligned curves 1601, unaligned curves 1603). Surprisingly, it is clear that the barrier in clean accuracy is eliminated with the use of alignment. With respect to robust accuracy, it can be seen that that alignment significantly alleviates that barrier for the TinyTen and ResNet32 models. With VGG16, we have found that this barrier is still present, even though the training loss is lower in the aligned case. This is because the training of robust VGG16 models was found to overfit on the adversarial attacks on the training set. This is evident in that the average robust loss of the unaligned/aligned VGG16 curves on the training data is 2.40±0.00/2.24±0.01, while it is 3.82±0.02/4.06±0.02 on the test data. Thus, the skilled artisan will appreciate why VGG16 produced less than desirable results in some circumstances. Thus, this is not believed to be a problem with the aligned curve finding method, but a problem with the generalization of robust VGG16 models. FIGS. 52A-54C (aligned curves 1601, unaligned curves 1603) display these results for CIFAR10—FIGS. 52A-52C show training loss for training a robust curve between two robust models on CIFAR10, while FIGS. 53A-54C show Clean (FIGS. 53A-53C)/Robust (FIGS. 54A-54C) accuracy on these curves. Overfitting on VGG16 is apparent.

Aligned curves can find more accurate robust models. Neuron alignment seems successful at finding a curve between robust models along which models maintain their robustness to PGD attacks without sacrificing clean accuracy. Results provide evidence that the presence of a large robust loss barrier between robust can mostly be attributed as an artifact of symmetry in the loss landscape resulting from the network weights.

For CIFAR100, alignment enables finding a more accurate model without sacrificing robust accuracy, which provides new insight towards overcoming the issue of robustness accuracy tradeoff in adversarial robustness. Consider the midpoint on the ResNet32 aligned curve in FIG. 23A-25C, where both clean and robust accuracies increase by 5.3% and 1.3%, respectively, in comparison to the endpoints. For TinyTen, these accuracies also increase at the aligned curve midpoint, while no better model in term of clean or robust accuracy exists along the unaligned curve with respect to the endpoints. Learning a better model from scratch is not an easy task. In practice, converging requires an initial step size large enough for the SGD trajectory to reach this basin within feasible training time, that is also small enough to converge in the basin. Thus, the aligned curve finding can be viewed as a technique for avoiding aggressive hyperparameter tuning, which is typically expensive.

It will be appreciated that one or more embodiments generalize the curve finding problem by removing the weight symmetry ambiguity associated with the endpoint models. The optimal permutation of these weights can be approximated using neuron alignment. We have found empirically that this approximation performs comparably to a proximal alternating scheme with the same initialization that learns a locally optimal permutation. Additionally, this PAM scheme has some convergence guarantees. Neuron alignment can be used to successfully and efficiently learn optimal connections between neural nets. Addressing the ambiguity of weight symmetry is pertinent for learning planar curves on the loss surface along which accuracy is mostly constant. Results hold true over a range of datasets and network architectures. With neuron alignment, these curves can be trained in fewer epochs and to higher accuracy. Surprisingly, with alignment we have also found that robust models are in fact connected on the loss surface and curve finding serves as a technique to identify more accurate robust models.

One or more embodiments use network alignment to find more accurate and robust models. One or more embodiments do not involve detection. One or more embodiments do not require consideration of missing features to improve robustness.

In the curve finding algorithm of FIG. 49, the optimization step can correspond to a variety of techniques. One or more non-limiting embodiments use traditional stochastic gradient descent to update the curve parameters φ. Notice that stochasticity is introduced by the sampling oft as well as the training data. For the purpose of computing validation loss and test loss for r_{φ}, care should be given for networks that contain batch normalization layers. This is because batch normalization aggregates running statistics of the network output that are used when evaluating the model. Though, r_{φ}(t₀) gives the weights for the model at point to, the running statistics should be aggregated for each normalization layer. In practice, this can be done by training the model for one epoch, while freezing all learnable parameters of the model. Since batch statistics would typically need to be computed for each point sampled along the curve, it happens that computing the validation or test loss of the curve r_{φ} is more expensive than an epoch of training.

For the following proofs, first establish and more rigorously define some terminology. For clarity, the parameterized curve connecting networks under some permutation P that has been written as r_{q}(t) will now sometimes be referred to as r(t; φ, P).

Feed-forward neural networks. Consider feed-forward neural networks. Let X₀∈R^{m0×d} be the input to the neural network, d samples of dimension m₀. Then let Wᵢ∈R^{mi×mi-1} denote the network weights mapping from layer l−1 to layer l. Additionally, a denotes the pointwise activation function. Express the output of a feed-forward neural network, Y, as:

Y:=W_{L}σ∘W_{L-1}σ∘W_{L-2} . . . σ∘W₁X₀ (₉)

To include biases, {bᵢ}ᵢ₌₁^{L}, simply convert to homogeneous coordinates:

$${\hat{X}}_{0} = [ \begin{matrix}{X}_{0} \\ 1\end{matrix} ] , {\hat{W}}_{i} = [ \begin{matrix}{W}_{i} & {b}_{i} \\ 0 & 1\end{matrix} ] , \hat{Y} = [ \begin{matrix}Y \\ 1\end{matrix} ] \qquad ( 10 )$$

In all proofs, these terms are interchangeable.

Huberized ReLU. The commonly used ReLU function is defined as σ(t):=max(0, t). However, this function is not in C¹ and hence not locally Lipschitz differentiable. This makes conducting analysis with this function difficult. Thus, approach studying it through the lens of the Huberized ReLU function, defined as:

$${σ}_{δ} ( t ) := \{ \begin{matrix}0 & for t \leq 0 \\ \frac{1}{2 δ} {t}^{2} & for 0 \leq t \leq δ \\ t - \frac{δ}{2} & for δ \leq t\end{matrix} \qquad ( 11 )$$

It is clear that σ_{δ} is a C¹ approximation of σ such that σ_{δ}∥∞=δ Using Huberized forms of loss functions for analysis is a fairly common technique (e.g. Huberized support vector machines).

FIGS. 55A-55C show the correlation signature for robust TinyTen networks trained on CIFAR100. FIGS. 56A-56C show the correlation signature for robust TinyTen networks trained on CIFAR10. The signatures before and after alignment are displayed at 5501, 5503, respectively.

Kurdyka-Lojasiewicz property. The function f is said to have the Kurdyka-Lojasiewicz (KL) property at x̅ if there exist v∈(0, +∞], a neighborhood U of x̅ and a continuous concave function ψ: [0,v)→R₊ such that:
ψ(0)=0
ψ is C¹ on (0,ν)
∀s∈(0,ν), ψ′(s)>0
∀x∈U∩[ƒ(x̅)<ƒ<ƒ(x̅)+ν], the Kurdyka-Lojasiewics inequality holds

ψ′(ƒ(x)−ƒ(x̅))dist(0,∂ƒ(x))≥1 (12)

Here ∂f denotes the subdifferential of f Informally, a function that satisfies this inequality is one whose range can be re-parameterized such that a kink occurs at its minimum. More intuitively, if ψ has the form, s^{1-θ} with θ in (0, 1), and f is differentiable on (0, v), then the inequality reduces to:

$$\frac{1}{( 1 - θ )} {\vert f ( x ) - f ( \overline{x} ) \vert}^{θ} \leq ‖ ∇ f ( x ) ‖ \qquad ( 13 )$$

Semialgebraic function. A subset of Rⁿ is semialgebraic if it can be written as a finite union of sets of the form:

{x∈ [symbol] ⁿ:pᵢ(x)=0,qᵢ(x)<0,i={1,2, . . . ,p}} (14)

where pᵢ and qᵢ are real polynomial functions. A function f: Rⁿ→R∪{+∞} is said to be semialgebraic if its graph is a semialgebraic subset of Rⁿ⁺¹.

Subanalytic function. Globally subanalytic sets are sets that can be obtained through finite intersections and finite unions of sets of the form {(x, t)∈[−1, 1]ⁿ×R: f(x)=t} where f: [−1, 1]ⁿ→R is an analytic function that can be extended analytically on a neighborhood of the interval [−1; 1]ⁿ. A function is subanalytic if its graph is a globally subanalytic set.

Proof of convergence theorem: To prove this, show that the problem meets the conditions required for local convergence of proximal alternating minimization (PAM) described in Attouch, H., Bolte, J., Redont, P., and Soubeyran, A., Proximal alternating minimization and projection methods for nonconvex problems: An approach based on the Kurdyka-Lojasiewicz inequality, Mathematics of Operations Research, 35(2):438-457, 2010. This requires the following: 1. Each term in the objective function containing only one primal variable is bounded below and lower semi-continuous; 2. Each term in the objective function which contains both variables is in C¹ and is locally Lipschitz differentiable; and 3. The objective function satisfies the Kurdyka-Lojasiewicz (KL) property. First, reformulate the problem so that it becomes unconstrained. Let χ denote the indicator function, where:

$$𝒳C ( t ) := \{ \begin{matrix}0 , & for t ∈ C \\ + ∞ , & otherwise\end{matrix} \qquad ( 14 )$$

This problem contains two hard constraints. First, each permutation matrix, Pₗ, must clearly be restricted to the set of permutation matrices of size |Kₗ|, Π_{|Kl|}. Additionally, it is assumed that the norm of the weights are bounded above. Without loss of generality, let K_{W} denote an upper bound valid for all the weights. Denote the set of weights that satisfy the norm constraint as {A:∥A∥₂²≤K_{W}}. Then equation (5) with added regularization is equivalent to:

$${ϕ}^{*} , {P}^{*} = arg {min}_{ϕ , P} Q ( ϕ , P ) + {\sum }_{l = 1}^{L - 1} 𝒳 {\prod }_{\vert {K}_{l} \vert} ( {P}_{l} ) + {\sum }_{l = 1}^{L} {𝒳}_{\{ A : {‖ A ‖}_{2}^{2} < {K}_{w} \}} ( {W}_{l} ) \qquad ( 15 )$$

Now address each requirement for local convergence. From equation (14), see that the sum of indicator functions are bounded below and lower semi-continuous. Now consider the form of the function, Q(φ, P). It has been defined as:

∫ₜ₌₀¹ [symbol] (r(t;ϕ,P))dt

Note that r(t; φ, P) corresponds to a feed-forward neural network. Then Q can be expressed as:

∫ₜ₌₀¹ [symbol] (W_{L}(t;ϕ,P)σ∘W_{L-1}(t;ϕ,P) . . . σ∘W₁(t;ϕ,P)X₀)dt (16)

with weight matrices Wᵢ and activation function σ. It becomes clear that for Q(φ, P) to be in C¹ and locally Lipschitz differentiable, the same must be true for [symbol] σ, and {Wᵢ}ᵢ₌₁^{L}. The first two are true as they are assumptions of the theorem. Since, r_{φ} is in C¹ and locally Lipschitz differentiable in the primal variables, then this is also true for all Wᵢ. Thus, Q(φ, P) is in C¹ and locally Lipschitz differentiable.

To satisfy the KL property, the objective function should be a tame function as per the above-mentioned Attouch paper. Rigorously, this means that the graph of the function belongs to an o-minimal structure, a concept from algebraic geometry.

Note that Q(φ, P) is piece-wise analytic. This is because Q is a composition of piece-wise analytic functions, [symbol] σ, and r_{φ}. Additionally, because the input data is bounded and the norm of the weight matrices are bounded, it follows that the domain of Q is bounded. Since, Q is a piece-wise analytic function with bounded domain, it follows that Q is a subanalytic function. The boundedness of the domain is an important detail here. This is because analytic functions are not necessarily subanalytic unless their domain is bounded; a popular example of such a function is the exponential function.

Now, consider the constraints associated with this problem, which have been re-expressed as indicator functions in the objective. The set of permutation matrices, Π_{|Kl|}, is finite and thus it is clearly a semi-algebraic set. Notice that the set of weight matrices satisfying the norm bound is equivalent to {A: ∥A∥₂²−K_{W}<0}. The function that defines this set is a polynomial, so it is a semi-algebraic set. Indicator functions on semi-algebraic sets are semialgebraic functions. Thus, the indicator functions in the objective are semi-algebraic.

The graphs of semi-algebraic functions and subanalytic functions both belong to the logarithmic-exponential structure, an o-minimal structure. A basic algebraic property of o-minimal structures is that the graphs of addition and multiplication are also elements of the structure. Since the objective function is a linear combination of semialgebraic functions and subanalytic functions, it follows that the graph of the objective function is an element of the logarithmic-exponential structure. Therefore, the objective function is a tame function and it satisfies the KL property.

Considering Rectified Networks. The convergence theorem does not extend to the class of rectified networks. However, consider constructing a sequence of iterates {φ^{k}, P^{k}} such that the objective value, [symbol] _{t˜U}[ [symbol] (r(t; ϕ^{k}, P^{k}))], is monotonic decreasing. The following theorem will introduce a technique for constructing such a sequence.

Lemma C.1 ( [symbol] restricted to possible network outputs is Lipschitz continuous). For a feed-forward neural network, assume that [symbol] is continuous and that the neural network input, X₀, is bounded. Additionally, assume that the spectral norm of all weights, {Wᵢ}ᵢ₌₁^{L}, is bounded above by K_{W}, and the activation function, σ, is continuous with ∥σ∥≤1. Let S_{Y} denote the set of Y where:

Y=W_{L}σ∘W_{L-1}σ∘W_{L-2} . . . σ∘W₁X₀

such that

∥Wᵢ∥₂≤K_{W}∀i∈{1,2, . . . ,L} (17)

Then [symbol] restricted to the set S_{Y} is Lipschitz continuous with some Lipschitz constant K.

Proof. Since X₀ is bounded, it follows that there exists some constant K_{X} such that ∥X₀∥≤K_{X}. Since, the spectral norm of W₁ is bounded above by K_{W}, it is easy to see that ∥W₁X₀∥<K_{W}K_{X}. Now since the pointwise activation function is a non-expansive map, it immediately follows that ∥Γ∘W₁X₀∥≤K_{W}K_{X}. Following this process inductively, see that the network output, Y, is bounded and that:

∥Y∥≤K_{W}^{L}K_{X} (18)

Since Y is arbitrary, it follows that this is a bound for S_{Y}. Then we can restrict [symbol] to the ball in R^{mL×d} of radius K_{W}^{L}K_{X}. This ball is compact and [symbol] is continuous, so it follows that [symbol] restricted to this ball is Lipschitz continuous. Thus, there exists some Lipschitz constant K. Clearly, S_{Y} is contained in this ball. Therefore, [symbol] is Lipschitz continuous on the set of all possible network outputs with Lipschitz constant K.

Let θ₁ and θ₂ be feed-forward neural networks with ReLU activation function. Assume that [symbol] and r_{φ} are piece-wise analytic functions in C¹ and locally Lipschitz differentiable. Assume that the maximum network width at any layer is M units. Additionally, assume that the network weights have a spectral norm bounded above by K_{W}, and that this is a hard constraint when training the networks. Finally, any point on r_{φ} must be equivalent to an affine combination of neural networks (Bezier curves, polygonal chains, etc.) satisfying the previously stated spectral norm bound.

Create the parameterized curve r_{δ}(t; φ, P) by substituting the Huberized ReLU function, σδ, into all ReLU functions in r(t; φ, P). Refer to the objective values associated with these curves as Q_{δ}(φ, P) and Q(φ, P) respectively.

Theorem C.2 (Monotonic Decreasing Sequence for Rectified Networks). For a feed-forward network, assume the above assumptions have been met. Additionally, assume that X₀ is bounded, so that [symbol] restricted to the set of possible network outputs is Lipschitz continuous with Lipschitz constant K_{L} by Lemma C.1. Now generate the sequence {φ^{k}, P^{k}} by solving equation (6) for r_{δ}(t; φ, P). On this sequence impose the additional stopping criteria that:

$$\frac{1}{2 {v}_{ϕ}} {‖ {ϕ}^{k + 1} - {ϕ}^{k} ‖}_{2}^{2} + \frac{1}{2 {v}_{P}} {‖ {P}^{ k + 1} - {P}^{ k} ‖}_{2}^{2} \geq {K}_{L} \sqrt{M} \frac{δ}{2} {\sum }_{i = 1}^{L - 1} {K}_{W}^{i} \text{∀} K \geq 0. \qquad ( 19 )$$

Then, the sequence of curves r(t; φ^{k}, P^{k}) connecting rectified networks has monotonic decreasing objective value.

Proof. First, we consider the approximation error from replacing σ with σ_{δ}. It is straightforward to see that:

$${max}_{t} \vert σ ( t ) - {σ}_{δ} ( t ) \vert \leq \frac{δ}{2} . \qquad ( 20 )$$

Then it follows that for any input x,

$${‖ σ {oW}_{1} x - {σ}_{δ} o {W}_{1} x ‖}_{2} \leq \sqrt{M} \frac{δ}{2} .$$

Since the spectral norm of Wᵢ are bounded above by K_{W}, see that:

$${‖ {W}_{2} σ o {W}_{1} x - {W}_{2} {σ}_{δ} o {W}_{1} x ‖}_{2} \leq {K}_{W} \sqrt{M} \frac{δ}{2} .$$

Now notice that:

∥σ∘W₂σ∘W₁x−σ_{δ}∘W₂σ_{δ}∘W₁x∥≤∥σ∘W₂σ∘W₁x−σ∘W₂σ_{δ}∘W₁x∥+∥σ∘W₂σδ∘W₁x−σ_{δ}∘W₂σδ∘W₁x∥.

Since the ReLU function is a non-expansive map, it must be that the first term is bounded above by the previous error,

$${K}_{W} \sqrt{M} \frac{δ}{2} .$$

The second term corresponds once again to the error associated with the Huberized form of the ReLU function,

$$\sqrt{M} \frac{δ}{2} .$$

Thus, the total error can be bounded by

$$( {K}_{W} + 1 ) \sqrt{M} \frac{δ}{2} .$$

Following this inductively, it can be seen that this error grows geometrically with the number of layers. Additionally, the loss function is Lipschitz continuous when restricted to the set of possible network outputs. So, we find the following bounds:

$$‖ Y - {Y}_{δ} ‖ \leq \sqrt{M} \frac{δ}{2} {\sum }_{i = 1}^{L - 1} {K}_{W}^{i} \\ ‖ ℒ ( Y ) - ℒ ( {Y}_{δ} ) ‖ \leq {K}_{L} \sqrt{M} \frac{δ}{2} {\sum }_{i = 1}^{L - 1} {K}_{W}^{i} \qquad ( 21 )$$

Since any point on the curve is an affine combination of networks with the Kw bound on the spectral norm of their weights, it immediately follows this spectral norm bound also holds for the weights for any point on the curve. Then ∥Q(ϕ,P)−Q_{δ}(ϕ,P)∥ is also bounded above by the bound in equation (21).

Then let {φ^{k}, P^{k}} be the sequence generated by solving equation (6) using the curve r_{δ}. σ_{δ} is a piece-wise analytic function in C¹ and is locally Lipschitz differentiable. Additionally, the spectral norm constraint on the weights is semi-algebraic and bounded below, so the convergence theorem can be applied. It then follows that:

$$Q ( {ϕ}^{k + 1} , {P}^{ k + 1} ) + \frac{1}{2 {v}_{ϕ}} {‖ {ϕ}^{k + 1} - {ϕ}^{k} ‖}_{2}^{2} + \frac{1}{2 {v}_{P}} {‖ {P}^{ k + 1} - {P}^{ k} ‖}_{2}^{2} \leq Q ( {ϕ}^{k} , {P}^{ k} ) + {K}_{L} \sqrt{M} \frac{δ}{2} {\sum }_{i = 1}^{L - 1} {K}_{W}^{i} , \text{∀} k \geq 0 \qquad ( 22 )$$

Thus, r(t; φ^{k}, P^{k}) is a sequence of curves, connecting rectified networks, with monotonic decreasing objective value as long as:

$$\frac{1}{2 {v}_{ϕ}} {‖ {ϕ}^{k + 1} - {ϕ}^{k} ‖}_{2}^{2} + \frac{1}{2 {v}_{P}} {‖ {P}^{ k + 1} - {P}^{ k} ‖}_{2}^{2} \geq {K}_{L} \sqrt{M} \frac{δ}{2} {\sum }_{i = 1}^{L - 1} {K}_{W}^{i} \text{∀} k \geq 0$$

Since the above equation is a stopping criterion introduced in the theorem statement, it follows that a sequence of curves has been constructed, connecting rectified networks, with monotonic decreasing objective value.

Residual Network Alignment. Algorithm 1 applies to networks with a typical feed-forward structure. Now, consider how to compute alignments for the ResNet32 architecture as it is more complicated. It is important to align networks such that the network structure is preserved and network activations are not altered. In the context of residual networks, special consideration must be given to skip connections.

Consider the formulation of a basic skip connection:

Xₖ₊₁=σ∘(Wₖ₊₁Xₖ)+Xₖ₋₁ (23)

In this equation, see that Xₖ₊₁ and Xₖ₋₁ share the same indexing of their units. This becomes clear when you consider permuting the hidden units in Xₖ₋₁ without permuting the hidden units of Xₖ₊₁. It is impossible to do so without breaking the structure of the equation above, where there is essentially the use of an identity mapping from Xₖ₋₁ to Xₖ₊₁.

Consider a traditional residual network that is decomposed into residual blocks. In each block the even layers have skip connections while the odd layers do not. So, compute the alignment as usual for odd layers. For all even layers within a given residual block, determine a shared alignment. Do this by solving the assignment problem for the average of the cross-correlation matrix over the even layers in that residual block.

Alignment Along Curves. Clearly, alignment is a useful method for learning better flat loss curves between models. An interesting question is how curve finding itself relates to alignment. Until now, consideration was only given to the alignment between the endpoint models, r(0) and r(1). Now, consider how points along the curve, r(t), align to the endpoints. To study this numerically, use the curve midpoint r(0.5). From FIGS. 21A-22C, see that this is the point on the quadratic Bezier curve that is roughly linearly connected to both endpoints.

Correlation Signature. Consider how the correlation signature changes along the curve. FIGS. 57A-60C display the correlation signature between the curve midpoint and each endpoint at 5701. To gain a better understanding of this signature, consider some context. Thus, the correlation signature between the linear midpoint and each endpoint is displayed at 5703. This allows understanding how the correlation signature changes over the curve finding optimization. Additionally, the correlation signature is displayed between the curve midpoint and each endpoint, where the midpoint has been aligned to the given endpoint, at 5705. This essentially gives context on how highly the midpoint is aligned to each endpoint. This is because the curves at 5705 act as an upper bound for the curves at 5701.

There are several observations to be made about FIGS. 57A-60C. The correlation signature between the endpoint and the curve midpoint is fairly high. For unaligned endpoints, the correlation is only slightly lower than the signature computed when the curve midpoint is aligned to the endpoint. In the case where the endpoints are aligned, the signatures are seen to coincide. This suggests that the curve finding algorithm is finding the quadratic curve along which similar feature representations are being interpolated.

Concerning the linear midpoint, the correlation at the linear midpoint decays to 0 when endpoints are unaligned as the network goes deeper. When endpoints are aligned, the correlation signature at the linear midpoint is similar to the correlation signature at the curve midpoint. Since these linear connections between the endpoints are the initializations for the curve finding algorithm, this gives some intuition on how alignment works to give a better initialization.

FIGS. 57A-60C thus show the mean cross-correlation between units in the curve midpoint model and each endpoint model. For context, the mean cross-correlation between the linear midpoint and each endpoint is displayed. Additionally, the mean cross-correlation between the curve midpoint and each endpoint after being aligned to the respective endpoint is displayed.

Given the discussion thus far, it will be appreciated that, in general terms, an exemplary method, according to an aspect of the invention, includes (see step 801 in FIG. 8 and the input portion of Algorithm 1 in FIG. 14) obtaining, with at least one hardware processor, data specifying: two trained neural network models (θ₁ and θ₂), and alignment data. The alignment data could include, for example, training data X₀. A further step includes, with the at least one hardware processor, carrying out neuron alignment on the two trained neural network models using the alignment data to obtain two aligned models. Refer to step 803 in FIG. 8 and the output and nested FOR loops of Algorithm 1 in FIG. 14). Even further steps include, with the at least one hardware processor, training a minimal loss curve between the two aligned models, and with the at least one hardware processor, selecting a new model along the minimal loss curve that maximizes accuracy on adversarially perturbed data. Refer to step 805 in FIG. 8 and Algorithm 2 in FIG. 49.

The method just described can be carried out, for example, using software on a general purpose computer. Some embodiments can be partially or completely implemented in the cloud. Some embodiments can make use of one or more hardware accelerators. Some embodiments can employ, for example, a pre-processing module (for obtaining the data), an alignment module (for carrying out neuron alignment), and a loss curve analysis module (for training and selecting). The alignment module can include software (with optional hardware acceleration) to implement the output and nested FOR loops of Algorithm 1 in FIG. 14. The loss curve analysis module can include software (with optional hardware acceleration) to implement Algorithm 2 in FIG. 49. The pre-processing module could include, for example, READ statements or the like in a high-level language compiled or interpreted into computer-executable code. The processor implementing the method will typically be faster/use less CPU than prior art.

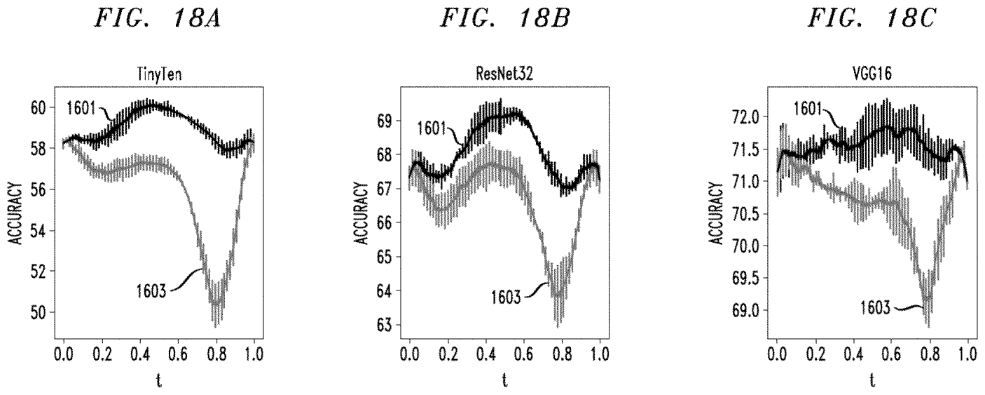

One or more embodiments further include implementing the new model on a computer (e.g. 10, 12 in FIG. 19) in an artificial intelligence application. This computer can include the hardware processor (e.g. 16) that carries out the algorithms, or can be a separate machine.

In a non-limiting example, the artificial intelligence application comprises computer vision, and a further step includes controlling at least one of a vehicle and a tool with the new model based at least in part on adversarial input. For example, referring to FIG. 19, one or more digital cameras 1993, 1995 (still and/or video) perceive a scene 1997 which includes one or more adversarial images. Using computer vision with an improved model as described herein, control tool and/or vehicle 1999, processing the adversarial data with the improved model. The computer vision or other AI will be more robust to adversarial data as compared to prior art techniques, with acceptable accuracy on uncorrupted data.

In one or more embodiments, carrying out of neuron alignment comprises: with the at least one hardware processor, computing correlations between hidden states of the two trained neural network models; and, with the at least one hardware processor, permuting (refer to P in FIG. 14) second model weights (refer in FIG. 14 to Ŵₗ² where superscript 2 refers to second model weight for l^{th} layer (subscript l)) to maximize correlation between corresponding hidden states.

Referring to iterative model search in FIG. 8, one or more embodiments further include, with the at least one hardware processor, substituting the new model for one of the two trained neural network models, and, with the at least one hardware processor, iteratively repeating the neuron alignment, training, and selecting steps to obtain a further refined new model. This further refined new model can then be implemented on a computer in an artificial intelligence application, as discussed above with respect to elements 1993, 1995, 1997, 1999 (e.g., controlling at least one of a vehicle and a tool with the further refined new model based at least in part on adversarial input using a computer vision system).

In a non-limiting example, training the minimal loss curve comprises applying stochastic gradient descent. As will be appreciated by the skilled artisan, for memory reasons, stochastic gradient descent is often used in AI applications as opposed to full gradient descent (which could of course be used if desired). Refer to FIG. 49 Algorithm 2, the FOR-END FOR construct.

In another aspect, an exemplary apparatus includes a memory (e.g. 30); a non-transitory computer readable medium (e.g. 34) including computer executable instructions; and at least one processor 16, coupled to the memory and the non-transitory computer readable medium, and operative to execute the instructions to be operative to carry out any one, some, or all of the method steps described herein. The non-transitory computer readable medium can include, for example, the pre-processing module (for obtaining the data), the alignment module (for carrying out neuron alignment), and the loss curve analysis module (for training and selecting).

One or more embodiments of the invention, or elements thereof, can be implemented in the form of an apparatus including a memory and at least one processor that is coupled to the memory and operative to perform exemplary method steps. FIG. 19 depicts a computer system that may be useful in implementing one or more aspects and/or elements of the invention, also representative of a cloud computing node according to an embodiment of the present invention. Referring now to FIG. 19, cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 19, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, and external disk drive arrays, RAID systems, tape drives, and data archival storage systems, etc.

Thus, one or more embodiments can make use of software running on a general purpose computer or workstation. With reference to FIG. 19, such an implementation might employ, for example, a processor 16, a memory 28, and an input/output interface 22 to a display 24 and external device(s) 14 such as a keyboard, a pointing device, or the like. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory) 30, ROM (read only memory), a fixed memory device (for example, hard drive 34), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 16, memory 28, and input/output interface 22 can be interconnected, for example, via bus 18 as part of a data processing unit 12. Suitable interconnections, for example via bus 18, can also be provided to a network interface 20, such as a network card, which can be provided to interface with a computer network, and to a media interface, such as a diskette or CD-ROM drive, which can be provided to interface with suitable media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 16 coupled directly or indirectly to memory elements 28 through a system bus 18. The memory elements can include local memory employed during actual implementation of the program code, bulk storage, and cache memories 32 which provide temporary storage of at least some program code in order to reduce the number of times code must be retrieved from bulk storage during implementation.

Input/output or I/O devices (including but not limited to keyboards, displays, pointing devices, and the like) can be coupled to the system either directly or through intervening I/O controllers.

Network adapters 20 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 12 as shown in FIG. 19) running a server program. It will be understood that such a physical server may or may not include a display and keyboard.

One or more embodiments can be at least partially implemented in the context of a cloud or virtual machine environment, although this is exemplary and non-limiting. Reference is made back to FIGS. 1-2 and accompanying text. Consider, e.g., a cloud-based service 96 (or one or more elements thereof) to facilitate efficient search of robust accurate neural networks, located in layer 90.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described; e.g., the pre-processing module (for obtaining the data), the alignment module (for carrying out neuron alignment), and the loss curve analysis module (for training and selecting). The method steps can then be carried out using the distinct software modules and/or sub-modules of the system, as described above, executing on one or more hardware processors such as 16. Further, a computer program product can include a computer-readable storage medium with code adapted to be implemented to carry out one or more method steps described herein, including the provision of the system with the distinct software modules.

One example of user interface that could be employed in some cases is hypertext markup language (HTML) code served out by a server or the like, to a browser of a computing device of a user. The HTML is parsed by the browser on the user's computing device to create a graphical user interface (GUI).

Exemplary System and Article of Manufacture Details

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
obtaining, with at least one hardware processor, data specifying:
two trained neural network models; and
alignment data;
with said at least one hardware processor, carrying out neuron alignment on said two trained neural network models using said alignment data to obtain two aligned models;
with said at least one hardware processor, training a minimal loss curve between said two aligned models; and
with said at least one hardware processor, selecting a new model along said minimal loss curve that maximizes accuracy on adversarially perturbed data.

2. The method of claim 1, wherein said alignment data includes training data.

3. The method of claim 2, further comprising implementing said new model on a computer in an artificial intelligence application.

4. The method of claim 3, wherein said artificial intelligence application comprises computer vision, further comprising controlling at least one of a vehicle and a tool with said new model based at least in part on adversarial input.

5. The method of claim 3, wherein said carrying out of said neuron alignment comprises:
with said at least one hardware processor, computing correlations between hidden states of said two trained neural network models; and
with said at least one hardware processor, permuting second model weights to maximize correlation between corresponding hidden states.

6. The method of claim 2, further comprising:
with said at least one hardware processor, substituting said new model for one of said two trained neural network models; and
with said at least one hardware processor, iteratively repeating said neuron alignment, training, and selecting steps to obtain a further refined new model.

7. The method of claim 6, further comprising implementing said further refined new model on a computer in an artificial intelligence application.

8. The method of claim 7, wherein said artificial intelligence application comprises computer vision, further comprising controlling at least one of a vehicle and a tool with said further refined new model based at least in part on adversarial input.

9. The method of claim 2, wherein training said minimal loss curve comprises applying stochastic gradient descent.

10. A non-transitory computer readable medium comprising computer executable instructions which when executed by a hardware processor cause said hardware processor to perform a method of:
obtaining data specifying:
two trained neural network models; and
alignment data;
carrying out neuron alignment on said two trained neural network models using said alignment data to obtain two aligned models;
training a minimal loss curve between said two aligned models; and
selecting a new model along said minimal loss curve that maximizes accuracy on adversarially perturbed data.

11. The non-transitory computer readable medium of claim 10, wherein said alignment data includes training data.

12. An apparatus comprising:
a memory;
a non-transitory computer readable medium comprising computer executable instructions; and
at least one processor, coupled to said memory and said non-transitory computer readable medium, and operative to execute said instructions to be operative to:
obtain data specifying:
two trained neural network models; and
alignment data;
carry out neuron alignment on said two trained neural network models using said alignment data to obtain two aligned models;
train a minimal loss curve between said two aligned models; and
select a new model along said minimal loss curve that maximizes accuracy on adversarially perturbed data.

13. The apparatus of claim 12, wherein said alignment data includes training data.

14. The apparatus of claim 13, wherein said at least one processor is further operative to implement said new model in an artificial intelligence application.

15. The apparatus of claim 14, wherein said artificial intelligence application comprises computer vision, and wherein said at least one processor is further operative to control at least one of a vehicle and a tool with said new model based at least in part on adversarial input.

16. The apparatus of claim 14, wherein said carrying out of said neuron alignment comprises:
with said at least one processor, computing correlations between hidden states of said two trained neural network models; and
with said at least one processor, permuting second model weights to maximize correlation between corresponding hidden states.

17. The apparatus of claim 13, wherein said at least one processor is further operative to:
substitute said new model for one of said two trained neural network models; and
iteratively repeat said neuron alignment, training, and selecting to obtain a further refined new model.

18. The apparatus of claim 6, wherein said at least one processor is further operative to implement said further refined new model in an artificial intelligence application.

19. The apparatus of claim 18, wherein said artificial intelligence application comprises computer vision, and wherein said at least one processor is further operative to control at least one of a vehicle and a tool with said further refined new model based at least in part on adversarial input.

20. The apparatus of claim 13, wherein training said minimal loss curve comprises applying stochastic gradient descent.
